(19) United States
(12) Patent Application Publication
(10) Pub. No.: US 2019/0383627 A1
(43) Pub. Date: Dec. 19, 2019

(54) SYSTEM AND METHOD FOR VEHICLE OPERATION CONTROL

(71) Applicant: Skip Transport, Inc., San Francisco, CA (US)

(72) Inventors: Paul Nangeroni, San Francisco, CA (US); Shalin Mantri, San Francisco, CA (US); Mohit Wadhera, San Francisco, CA (US); Scott Bezek, San Francisco, CA (US)

(21) Appl. No.: 16/440,667

(22) Filed: Jun. 13, 2019

Related U.S. Application Data
(60) Provisional application No. 62/684,658, filed on Jun. 13, 2018.

(51) Int. Cl. G01C 21/34; B60W 30/14

(52) U.S. Cl. CPC G01C 21/3461; B60W 2550/22; B60W 30/146

(57) ABSTRACT

A method for controlling vehicle operation, including: determining vehicle operation rules, determining vehicle operation parameters, and controlling vehicle operation based on the vehicle operation rules.

### CROSS-REFERENCE TO RELATED APPLICATIONS

This application claims the benefit of U.S. Provisional Application No. 62/684,658, filed 13 Jun. 2018, which is incorporated in its entirety by this reference.

### TECHNICAL FIELD

This invention relates generally to the vehicle operation field, and more specifically to a new and useful method and system for controlling vehicle operation.

### BACKGROUND

Typical vehicles are frequently operated in undesirable manners, such as unsafely and/or in contravention to rules and laws governing their operation. Such undesirable operation is typically caused by vehicle occupants and/or operators, and many vehicles do not offer suitable mechanisms for external parties to prevent or reduce this undesirable operation. Thus, there is a need in the vehicle operation field to create a new and useful system and method for controlling vehicle operation. This invention provides such new and useful system and method for controlling vehicle operation.

### BRIEF DESCRIPTION OF THE FIGURES

FIG. 1 is a schematic representation of the method.

FIG. 2 is a schematic representation of the system.

FIG. 3 is a schematic representation of an embodiment of the system.

FIG. 4 is a schematic representation of an embodiment of the system.

FIG. 5 is a schematic representation of an embodiment of determining the primary geographic region and determining the secondary geographic region based on the primary geographic region.

FIG. 6 is a schematic representation of an embodiment of determining vehicle operation rules based on a direction of motion.

FIG. 7 is a schematic representation of examples of primary geographic region rules.

FIG. 8 is a schematic representation of an embodiment of controlling vehicle operation.

FIG. 9 is a schematic representation of an example of determining vehicle operation rules based on vehicle operation parameters.

FIG. 10 is a schematic representation of an embodiment of controlling vehicle operation.

FIG. 11 is a schematic representation of an embodiment of controlling vehicle operation.

FIG. 12 is a schematic representation of an embodiment of controlling vehicle operation.

FIG. 13 is a schematic representation of multiple variants of the method.

FIGS. 14A-14C depict specific examples of a vehicle of the system.

FIGS. 15A-15D depict specific examples of the vehicle operation rules.

FIG. 16 is a schematic representation of an embodiment of determining the secondary geographic region.

FIGS. 17A, 17B, and 17C are schematic representations of an example of the vehicle being considered as located within the compliance zone upon entry into the entry zone (wherein the primary geographic region rules are enforced on the vehicle); an example of an exiting vehicle being considered as located within the compliance zone while the vehicle is within the exit zone (wherein the primary geographic region rules are enforced on the vehicle); and an example of an exiting vehicle being considered as having left the compliance zone (wherein the primary geographic region rules are not enforced on the vehicle), respectively.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

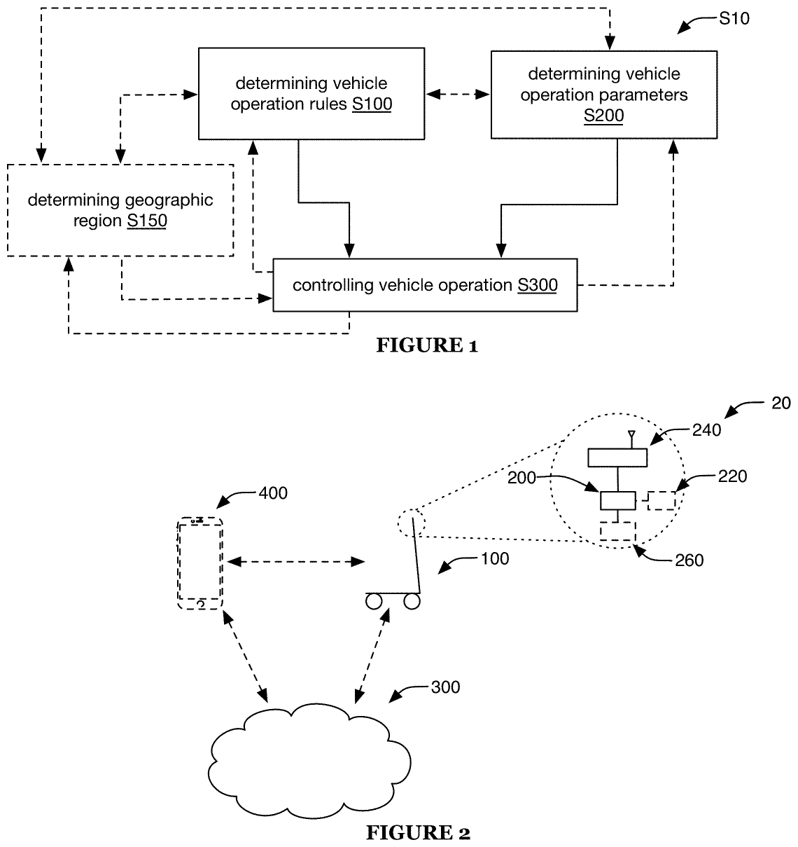

As shown in FIG. 1, a method S10 for controlling vehicle operation preferably includes determining vehicle operation rules S100, determining vehicle operation parameters S200, and controlling vehicle operation based on the vehicle operation rules S300, but can additionally or alternatively include any other suitable elements. As shown in FIG. 2, a system 20 for controlling vehicle operation preferably includes one or more vehicles 100 and one or more computing systems 200, but can additionally or alternatively include any other suitable elements.

The method S10 is preferably performed using the system 20, such as used to control the vehicle(s) of the system. However, the method S10 can additionally or alternatively be performed using any other suitable system.

An embodiment of the invention allows vehicle operation to be controlled automatically (i.e., independent of user input). In a specific embodiment of this invention, the vehicle control operation can be dynamically updated based on changes in vehicle operation parameters. Vehicle operation control can vary in different municipalities. In a specific embodiment of the invention, vehicle control operation is automatically enforced within a given primary geographic region.

In variants of the invention, the vehicle operation control can be enforced gradually over a primary geographic region or period of time to enforce the laws and/or policies. The gradual enforcement of the vehicle operation control precludes poor user experience due to sudden vehicle operation change.

### 2. Benefits.

The system and method for vehicle control can enable several benefits over current vehicle control schemes. First, variants of the vehicle control method can ensure user compliance with governmental ordinances by automatically enforcing vehicle operation rules. These variants do so by defining a set of vehicle operation rules that apply to vehicle operation, checking whether the vehicle is in compliance with those rules, and modify vehicle behavior when the vehicle is not in compliance.

Second, variants of the method ensure a positive vehicle user experience as the rules are applied. In particular, when applying the vehicle operation rules, user notifications are presented, informing the user before the rule goes into effect, as well as informing the user of the rule while it is in effect. Moreover, the vehicle operation rules are applied in a manner that provides a smooth transition in vehicle operation for the user. In variants, the smooth transition is ensured by defining a secondary geographic region that acts as a buffer zone around a primary geographic region. The buffer zone gradually transitions the vehicle operation rather than a sharp transition once the vehicle enters the primary geographic region. In other variants, vehicle operation parameters, when specified by vehicle operation rules, are reached by following target speed profiles that maintain a jerk of the vehicle below a target jerk. Ensuring that the vehicle jerk remains below a target jerk, helps to maintain smooth vehicle operation as vehicle operation rules are applied.

Third, variants of the method can ensure that the vehicle operation complies with government ordinances based on geographical regions. In variants with a primary geographic region with corresponding primary geographic region rules, secondary geographic regions (e.g., determined based on the primary geographic region, with corresponding secondary geographic region rules) can be defined. In a specific variant, different secondary geographic regions can be defined for entry into and exit from the primary geographic region. In this specific variant, having separate secondary geographic regions for entry and exit can ensure that sensor inaccuracy (e.g., location sensor noise; GPS noise) does not lead to false readings of the vehicle location. This can help ensure the vehicle operation remains in compliance with ordinances.

For example, the system can define an entry zone slightly outside of the compliance zone (e.g., separated from the compliance zone by the geographic inaccuracy distance conferred by GPS noise, etc.), such that the vehicle is considered within the compliance zone when the vehicle location falls within the entry zone. In another example, the system can define an exit zone slightly outside of the compliance zone (e.g., separated from the compliance zone by a multiple of the geographic inaccuracy distance conferred by GPS noise), such that the vehicle is considered within the compliance zone until the vehicle location falls outside the exit zone.

However, the system and method can confer any other suitable benefits.

### 3. System.

A system 20 for controlling vehicle operation preferably includes one or more vehicles 100 and one or more computing systems 200, but can additionally or alternatively include any other suitable elements.

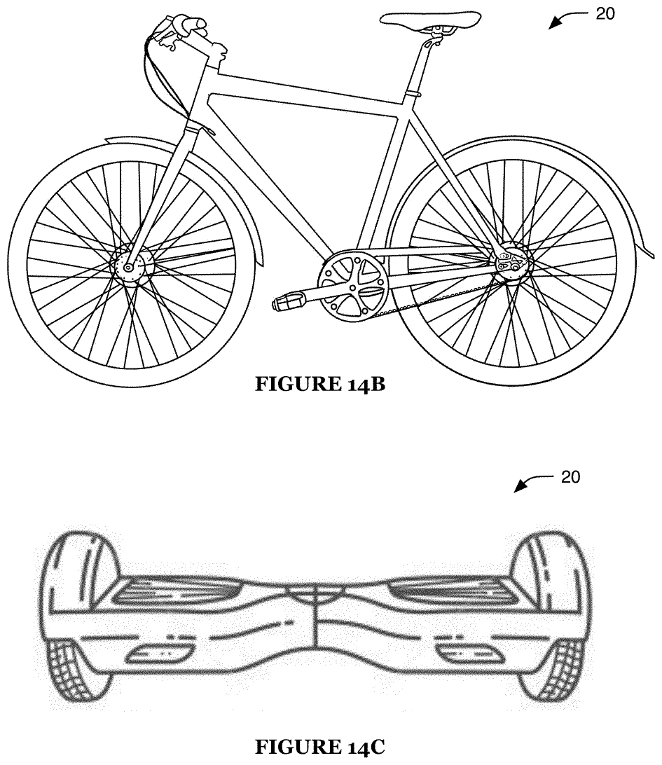

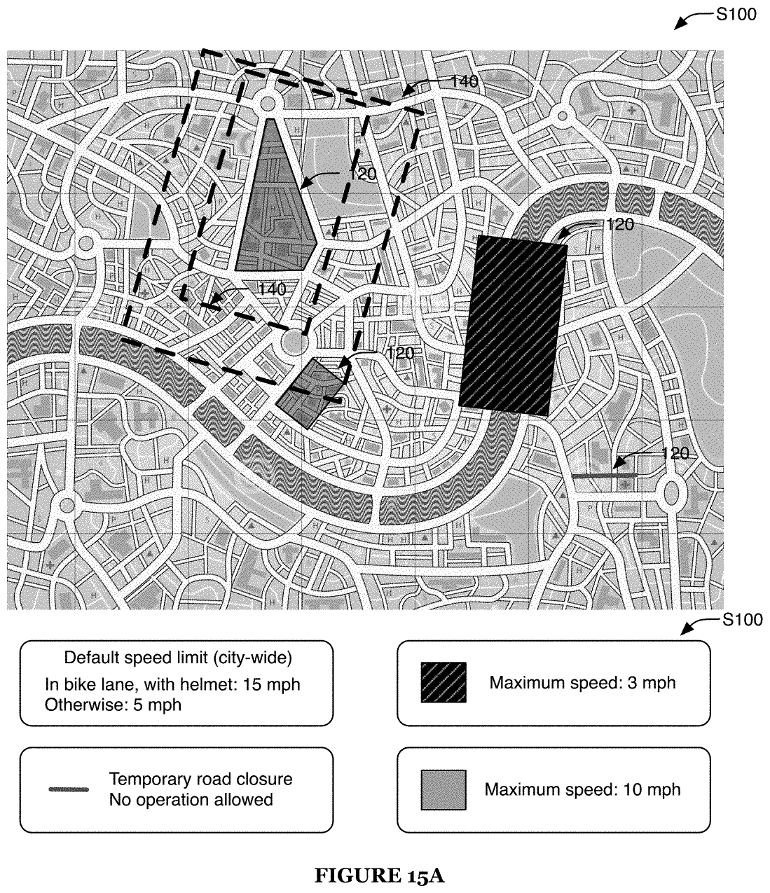

The system 20 preferably includes one or more vehicles 100. Each vehicle 100 is preferably a terrestrial vehicle, more preferably a wheeled vehicle. The vehicle 100 is preferably light-weight (e.g., less than a threshold weight, such as 10, 25, 50, 100, 150, or 200 lbs.) and/or compact, but can additionally or alternatively have any suitable size, shape, and/or weight. The vehicle 100 preferably transports one or more people (users, riders), which can include, for example: passengers such as drivers, operators, passive riders, and/or any other suitable vehicle users. For example, the vehicle can be operable to transport one person, two people, and/or any other suitable number of people. In examples, as shown in FIGS. 14A-14C, the vehicles can include: scooters (e.g., including two substantially inline wheels; a platform bridging the wheels and operable to support one or more riders, preferably standing riders; and/or a handle extending upward from the front wheel and/or platform, preferably operable to steer the scooter, such as by rotating the front wheel relative to the platform in response to handle rotation), unicycles, bicycles and/or tricycles, skateboards, velocipedes (and/or velocipedes modified to be additionally or alternatively propelled by mechanisms other than the rider(s), such as propelled by one or more electric motors), go-carts, super- and/or ultra-lightweight passenger vehicles, and/or any other suitable vehicles.

The vehicle is preferably a motorized vehicle (e.g., including one or more motors, preferably electric motors, operable to propel and/or control the vehicle), more preferably a remotely-controllable motorized vehicle (e.g., operable to receive control instructions from a remote controller, such as a remote computing system, and control or modify vehicle operation based on the instructions). The motorized vehicle preferably includes one or more motor controllers, which can be operable to accept control inputs from user input devices (e.g., vehicle-integrated devices, such as a throttle and/or brake control device, etc.), local computing system (e.g., user device), vehicle steering apparatus (e.g., steering wheel, handlebars, steering column, etc.), remote controllers, and/or any other suitable set of motor controllers.

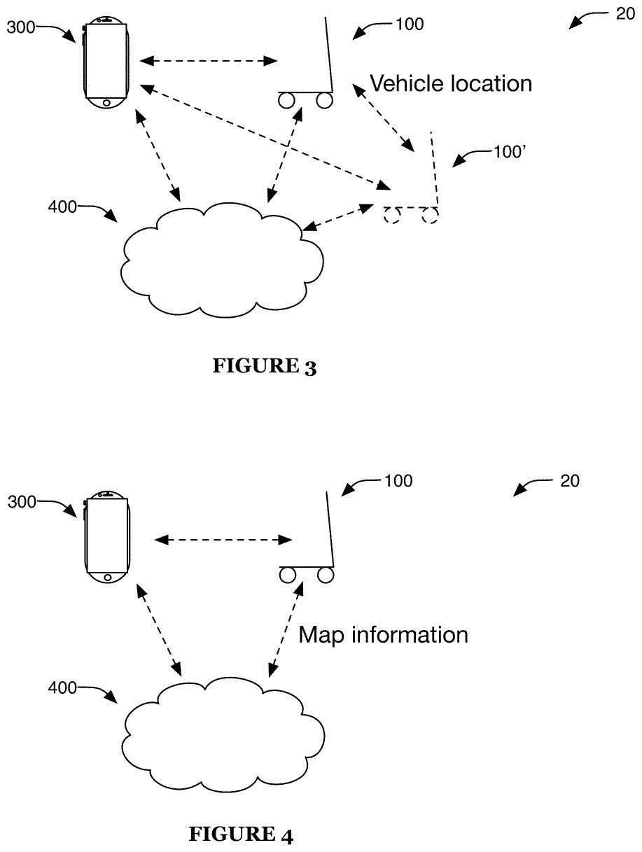

The vehicle preferably includes one or more communication systems 240 (e.g., wireless communication systems). The communication systems 240 function to provide communication between computing systems, user devices, other systems (e.g., other vehicles 100′; for example as shown in FIG. 3), remote computing systems (e.g., servers; for example as shown in FIG. 4), etc. The communication modules can include long-range communication modules (e.g., supporting long-range wireless protocols), short-range communication modules (e.g., supporting short-range wireless protocols), and/or any other suitable communication modules. The communication modules can include cellular radios (e.g., broadband cellular network radios), such as radios operable to communicate using 3G, 4G, and/or 5G technology, Wi-Fi radios, Bluetooth (e.g., BTLE) radios, NFC modules (e.g., active NFC, passive NFC), Zigbee radios, Z-wave radios, Thread radios, wired communication modules (e.g., wired interfaces such as USB interfaces), and/or any other suitable communication modules.

The vehicle preferably includes one or more sensors 260. The sensors 260 function to detect vehicle parameters (e.g., vehicle operation parameters, user parameters, etc.). The sensors 260 can include one or more: location sensors (e.g., GNSS and/or other geopositioning modules, such as receivers for one or more of GPS, GLONASS, BeiDou, Galileo, etc.; local positioning modules, such as modules enabling techniques such as triangulation, trilateration, multilateration, etc.), cameras (e.g., CCD, CMOS, multispectral, visual range, hyperspectral, stereoscopic, etc.), spatial sensors (e.g., inertial measurement sensors, accelerometer, gyroscope, altimeter, magnetometer, compasses, etc.), speedometer (e.g., tachometer, odometer, etc.), audio sensors (e.g., transducer, microphone, etc.), barometers, light sensors, thermal sensors (e.g., temperature and/or heat sensors, etc.), current sensor (e.g., Hall effect sensor, etc.), air flow meter, voltmeters, touch sensors (e.g., resistive, capacitive, etc.), proximity sensors, force sensors (e.g., strain gauge meter, load cell, scale, etc.), vibration sensors, chemical sensors, time of flight sensors (e.g., sonar, radar, lidar, rangefinder such as optical rangefinder, etc.), and/or any other suitable sensors. The sensors 26o can be mounted to any suitable location of the vehicle (e.g., handlebars, stem, wheel, deck, etc.), and can be oriented in any suitable orientation or pose (e.g., inward facing, outward facing, etc.).

The vehicle preferably includes one or more outputs. The outputs can include audio outputs (e.g., speakers), visual outputs (e.g., display screens, light emitters such as LEDs, etc.), haptic and/or tactile outputs (e.g., vibratory outputs), and/or any other suitable output elements.

The vehicle preferably includes one or more power sources. The power source preferably includes a battery, more preferably a secondary battery, but can additionally or alternatively can include a capacitor (e.g., to facilitate fast discharging in combination with a battery), a fuel cell with a fuel source (e.g., metal hydride), a thermal energy converter (e.g., thermionic converter, thermoelectric converter, mechanical heat engine, etc.) optionally with a heat source (e.g., radioactive material, fuel and burner, etc.), a mechanical energy converter (e.g., vibrational energy harvester), a solar energy converter, and/or any other suitable power source. However, the vehicle can additionally or alternatively include any other suitable power source elements.

The vehicle can additionally or alternatively include auxiliary elements. The auxiliary elements can be connected to the vehicle (e.g., wirelessly connected, such as by a short-range connection) or not connected. The auxiliary elements can include user safety equipment (e.g., helmet, safety pads, etc.), user parameter equipment (e.g., scale, breathalyzer, transdermal alcohol sensor, etc.), signaling equipment (e.g., visual signaling equipment (e.g., lights, LEDs, blinkers), audio signaling equipment (e.g., horns, bells, alarms, etc.), but can additionally or alternatively include any other suitable auxiliary equipment.

The system preferably includes one or more computing systems 200. The computing system(s) function to process vehicle inputs, determine vehicle operation control instructions, etc. The computing systems 200 are preferably in communication with the vehicle 100, but can additionally or alternatively be in communication with a control system 220, user devices, other vehicles, external computing systems 400, etc. The computing systems 200 are preferably mounted on the vehicle 100, but can additionally or alternatively include one or more remote computing systems 400 (e.g., network-connected servers), which are preferably operable to communicate with and/or control the vehicle (e.g., via one or more communication modules, preferably wireless communication modules), distributed between on-vehicle and external, and/or any suitable configuration.

The computing systems 200 can additionally or alternatively include or be used with one or more user devices (e.g., smartphones). For example, the user devices 300 can be operable to mediate user interactions with the vehicle. The user devices 300 can be operable to communicate directly with the vehicle (e.g., via one or more communication modules, preferably wireless communication modules), but can additionally or alternatively communicate with the vehicle via one or more other computing systems 200 (e.g., remote computing system) and/or in any other suitable manner (and/or not communicate with the vehicle). The computing systems can additionally or alternatively include one or more on-board processing systems. In one example, the on-board processing system is a user device (e.g., smartphone). In another example, the computing system is distributed across an on-vehicle computing system and a user device (e.g., smartphone). However, the system can include any suitable set of computing systems.

The computing systems 200 can additionally or alternatively include one or more control systems. The control system 220 functions to control the vehicle operation parameters. The control system 220 is preferably the same as the on-board processing system (e.g., mounted to the vehicle), but can additionally or alternatively be any other suitable computing system.

The computing systems 200 can include storage subsystems. The storage subsystems are preferably included in the computing systems, but additionally or alternatively the storage subsystems can include one or more remote computing systems 400 (e.g., cloud), be a user device, be distributed across multiple systems, and/or any suitable configuration. The storage subsystems are preferably non-volatile, but can additionally or alternatively be semi-volatile, volatile, and/or any suitable combination of volatility and/or any suitable system. The storage subsystem is preferably flash memory, but can additionally or alternatively be RAM, ROM, or any other suitable storage subsystem.

In a specific embodiment, the computing systems can preferably include a user device 300. The user device 300 can preferably be in communication with the vehicle, with the computing systems, the processing systems, the control systems, other vehicles, external computing systems 400, other user devices, and/or any suitable components. The user device 300 is preferably mounted to the vehicle (e.g., user device holder), but can additionally or alternatively remain in the user's possession and/or be located in any location. The user device 300 can wirelessly connect to the vehicle, be wired to the vehicle, be indirectly connected to the vehicle (e.g., wherein the vehicle and the user device are both connected to the remote computing system), be disconnected from the vehicle (e.g., communicably and/or physically), or be otherwise connected to the vehicle. The user device 300 is preferably distinct from the computing system, but can additionally or alternatively be the same as the computing system, a subsystem of the computing system, and/or any suitable configuration. In a specific embodiment of the invention, the user device 300 can communicate with a client application.

### 4. Method.

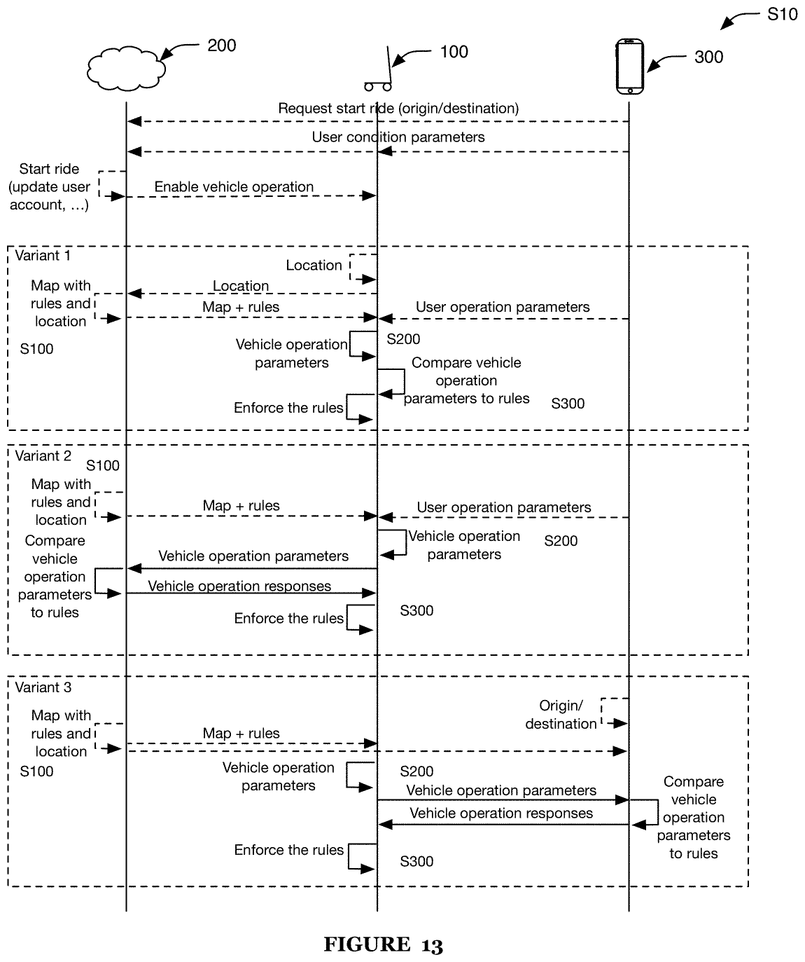

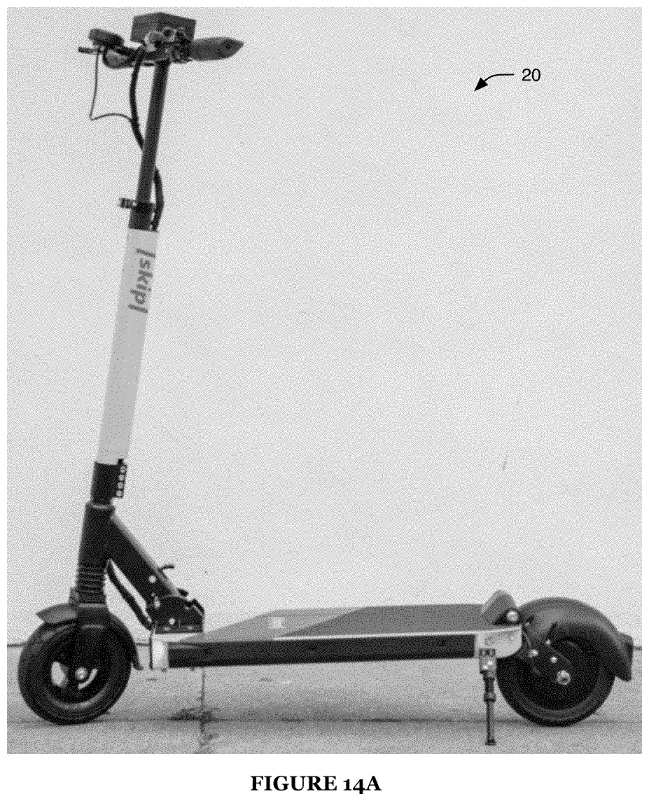

A method S10 for controlling vehicle operation includes determining vehicle operation rules, determining vehicle operation parameters, and controlling vehicle operation based on the vehicle operation rules, for example as shown in FIG. 13, but can additionally or alternatively include any other suitable elements. The method functions to dynamically control vehicle operation based on the vehicle operation context.

### 4.1 Determining Vehicle Operation Rules.

Determining vehicle operation rules S100 preferably functions to determine rules for controlling and/or limiting vehicle operation (e.g., vehicle operation rules) and the responses for meeting and/or failing to meet the rule conditions. Determining vehicle operation rules S100 preferably occurs before determining vehicle operation parameters S200, but can additionally or alternatively occur simultaneously with or after determining vehicle operation parameters S200. The rules are preferably determined by the computing systems 200 and more preferably by the processing subsystems, but can additionally or alternatively be determined by any suitable component. The rules can include rules that are more and/or less restrictive than the default vehicle behavior (e.g., than a default rule or rules, such as a default rule associated with all cases for which an alternate rule is not determined).

The vehicle operation rules are preferably determined by the vehicle 100, but can additionally or alternatively be determined at a remote computing system 400 (e.g., internet-connected server), user device 300 (e.g., computing device such as a smart phone or computer), the control system 220, and/or any other suitable device. Determining the rules S100 can include: retrieving the rules (e.g., from the remote computing system, on-board memory, from another device), receiving the rules (e.g., from an intermediary device, such as the user device; from a vehicle operation controller; from the remote computing system; etc.), calculating the rules (e.g., extrapolating the rules, calculating the rules using an equation), looking up the rules (e.g., from a lookup table, map, regulations, etc.), learned (e.g., from historic riding sessions for the geographic area or unit, from historic riding sessions for the user or a population thereof), or otherwise determining the rules.

The rules can be determined based on: current vehicle operation parameters; operation context parameters (e.g., time of day, weather, etc.); target vehicle operation parameters (e.g., vehicle operation conditions associated with the current set of vehicle operation parameters, such as the current vehicle location); anticipated target vehicle operation parameters (e.g., vehicle operation conditions associated with an anticipated set of vehicle operation parameters); and/or any other suitable set of variables.

The vehicle operation rules can be determined before vehicle operation, during vehicle operation, and/or at any other suitable time. The vehicle operation rules can be determined once (e.g., at the start of system operation), at the beginning of a trip, continuously (e.g., throughout system operation), periodically (e.g., with a predetermined frequency such as every 15 seconds, every 6o seconds, etc.), dynamically updating (e.g., in response to the occurrence of an action or event, such as determination of a turn; crossing a primary geographic region; when a vehicle operation parameter satisfies a vehicle operation condition; when a connectivity condition, such as the availability of a WiFi network, is met; at a predetermined time of the day; in response to determination of a change in vehicle operation condition, etc.), when the user instructs the system to check for vehicle operation rules, at a time period that depends on user parameter (e.g., age, user history, user preferences, etc.), at preprogrammed times, when the remote computing system pushes an updated rule set, when the remote computing system determines that the locally stored rules are outdated (e.g., wherein a rule packet version number sent with the vehicle data to the remote computing system is different from the current rule packet version number), and/or at any other suitable time.

The rules can be stored at the remote computing system (e.g., wherein sensor signals and/or derivatives thereof are transmitted to the remote computing system for processing and operation instruction determination), at the vehicle (e.g., wherein the vehicle locally enforces the rules), and/or otherwise stored.

The locally-stored rules can be for: the geographic region proximal the vehicle; the geographic area within a predetermined distance of the anticipated vehicle route; high-frequency geographic areas; the entire geographic area associated with a municipality or other controlling entity; or for any other suitable set of geographic area. The locally-stored rules can be: retrieved from the control system (and/or remote computing system), updated based on retrieved rule information (e.g., primary geographic region information, secondary geographic region information, etc.), or otherwise updated. The rule information can specify the entire rule set, specify the conditions, specify the responses, specify the difference between rule versions, or include any other suitable set of information.

The operation rules can be implemented by the control system 220 of the computing system, but can additionally or alternatively be implemented by a user device, by the external computing system 400, by the vehicle, manually, and/or by any other suitable system.

In a specific embodiment, the vehicle operation rules can be retrieved from a remote computing system for a given geographic unit or region. A geographic unit can be a standard geographic area (e.g., every 2 m×2 m geographic area within a geographic grid), or be otherwise defined. The geographic unit that the rules are retrieved for can be: the geographic unit that the vehicle is currently in, the next set of geographic units that the vehicle has a high probability of vehicle entry, or any other suitable set of geographic units. A geographic region can be a nonstandard (or standard) geographic area, and can encompass one or more geographic units. The geographic region that the rules are retrieved for can be: the region proximal or surrounding the vehicle location (e.g., a predetermined radius away from the vehicle location; the maximum distance that the vehicle can travel based on the current vehicle's operation parameters and condition parameters, such as the current state of charge or discharge rate; etc.), the geographic region extending along the expected vehicle route (e.g., based on the rider's origin and destination), and/or any other suitable geographic region. The boundary of a geographic region is preferably a sharp boundary (e.g., a fixed boundary delineated by specific streets, coordinates, points of interest, bodies of water, bridges, train tracks, bicycle paths, etc.). Alternatively, the boundary of the geographic region can be fuzzy (e.g., dynamically updating, depending on vehicle operation parameter, depending on user parameter, etc.). Alternatively or additionally, the boundary of the geographic region can be defined in any suitable manner. The boundary of a geographic region is preferably within the geographic region. Alternatively or additionally, the boundary of the geographic region can be outside the geographic region, define a separate geographic region, or be defined in any other suitable manner.

In a specific embodiment, the vehicle operation rules can be retrieved based on the vehicle route (e.g., planned route, high-probability route, etc.). The rules associated with the geographic regions along the vehicle route are preferably retrieved; however, any other suitable set of rules can be retrieved based on the vehicle route. The vehicle route can be a planned route (e.g., determined from a navigation application, based on the rider's origin and/or destination); a high-probability route (e.g., determined from user history, other user ride history for the primary geographic region, based on vehicle bearing, etc.); or be any other suitable route.

The vehicle operation rules are preferably received from a vehicle operation controller (or multiple controllers). The vehicle operation controller(s) can include: employees, contractors, and/or other workers associated with a vehicle service (e.g., service that provides one or more vehicles for use, such as a vehicle rental, leasing, sales, and/or maintenance service; service that manages vehicle operation, etc.); authorized agents associated with a vehicle operation location and/or jurisdiction (e.g., workers associated with a municipality, such as city employees; land owners and/or renters, and/or their designees; etc.); and/or any other suitable vehicle operation controller(s). The vehicle operation controllers are preferably different from the vehicle users, but can alternatively be the same.

In one embodiment, geospatial regions associated with vehicle operation rules are input (e.g., graphically, such as by selecting a box, defining vertices of a polygon, and/or tracing a path; semantically, such as by providing information such as addresses, street intersections, and/or landmark identifiers; etc.) by the vehicle operation controller (e.g., using a rule definition interface). In one embodiment, vehicle operation conditions (e.g., restrictions such as maximum speed, additional criteria such as safety factors, etc.) can be associated with the geospatial region(s), such as by using vehicle operation rule templates (e.g., predefined vehicle operation rule templates), by selecting vehicle operation rule elements (e.g., individually), and/or in any other suitable manner. However, the vehicle operation rules (and/or elements thereof) can additionally or alternatively be received in any other suitable manner.

The vehicle operation rules can be determined manually, automatically (e.g., by a computing system 200 such as a remote computing system 400), or otherwise determined. For example, the vehicle operation rules can be determined based on news events, calendar entries (e.g., associated with events such as parades and/or construction), event feeds (e.g., parade scheduled, construction permit issued, parking restriction set, etc.), municipal ordinances, generated from other vehicle operation rules, learned (e.g., using computer learning based on previous user experiences in a region, based on a user population's behavior, such as behavior of “good” users, etc.), computer vision (e.g., camera captures image of regulatory signs), and/or any other suitable information. In one example, one or more criteria associated with the rules (e.g., geospatial region and/or effective time) are determined automatically (e.g., based on the information described above, such as region and time matching the associated event), and the automatically-determined criteria are associated with rules (e.g., maximum vehicle speed) and/or additional criteria (e.g., vehicle users must wear helmets, vehicles must be operated on bike lanes and/or bike paths, etc.), preferably based on the event type (e.g., wherein the rules and/or additional criteria are predetermined in association with an event type). In another example, the rules can be received from a user. However, the rules can be otherwise determined.

The vehicle operation rules are preferably defined by conditional statements (e.g., if-then statements), but can additionally or alternatively be defined by lookup tables, graphical, chart, computed from an equation (e.g., linear, logarithmic), and/or any suitable formation. In a specific example, the vehicle operation rules are defined by an equation that depends on the user parameters (e.g., user mass), vehicle operation parameters (e.g., vehicle speed, acceleration, road conditions, etc.), and vehicle condition parameters (e.g., braking strength, fraction of braking power remaining, etc.). However, the vehicle operation rules can be otherwise calculated based on any other suitable set of vehicle operation parameters.

The same set of vehicle operation rules are preferably applied for all users in all contemporaneous instances of vehicle operation (e.g., rides within a predetermined time frame, concurrent rides, etc.). However, the vehicle operation rules can be applied depending on user parameters; be the same for one user on all instances of vehicle operation for that user (e.g., based on user preferences, a user profile, etc.); change for a given user, from instance of vehicle operation to another instance of vehicle operation (e.g., based on user parameters such as ride history, age, gender, vision, hearing, user preferences, user settings, population history, rider history for the primary geographic region, rider history for the vehicle or class thereof, etc.); change in the middle of vehicle operation; change based on the number of users within the geographic region (e.g., based on the active riding session density); and/or based on any suitable user metrics.

The vehicle operation rules are preferably applied based on the vehicle operation parameters (e.g., ambient environment, state of charge of power source, vehicle age, vehicle wear, enabled status, etc.). Additionally or alternatively, the vehicle operation rules can be applied to all rides, to a subset of rides (e.g., determined by a vehicle operator), when conditions for vehicle operation rule application are met, based on external conditions (e.g., weather, road conditions, etc.), based on time (e.g., time of day, day of the week, season, holidays, events calendar, etc.), depending on ride origin and destination, dynamically varying (e.g., vehicle operation rules depend on vehicle operation parameters), and/or any suitable time period for rule application.

The vehicle operation rules are preferably strictly enforced, but can additionally or alternatively be loosely enforced (e.g., vehicle operation rule enforcement is contingent upon vehicle operation parameters, user parameters, vehicle condition parameters, etc.), optional, and/or have any suitable priority.

The vehicle operation rules preferably include vehicle operation conditions and vehicle operation responses. The vehicle operation conditions preferably trigger the vehicle operation response application or enforcement when the vehicle operation conditions are met, but can be otherwise used.

The vehicle operation conditions preferably include a set of vehicle operation parameters that trigger vehicle operation responses, but can additionally or alternatively include a set of trigger vehicle context parameters, a set of trigger events, or any other suitable condition. Additionally or alternatively, the vehicle operation conditions can be determined based on any other suitable parameter (e.g., vehicle condition parameters, user parameters, geospatial region, etc.).

The vehicle operation responses preferably include (and/or are determined based on) a set of target vehicle operation parameters (e.g., vehicle operation parameters to meet within a predetermined time period, distance, etc.), but can additionally or alternatively include an equation, a set of vehicle control instructions, or be any other suitable response. The vehicle operation response can be the same for a given vehicle operation condition, but can additionally or alternatively be different for each instance of vehicle operation condition satisfaction (e.g., based on the instantaneous vehicle operation parameter value, the vehicle condition parameters, the traction conditions, etc.). Additionally or alternatively, the vehicle operation responses can be determined based on and/or affect any other suitable parameter (e.g., vehicle condition parameters, user parameters, geospatial region, etc.).

The vehicle operation parameters can include: kinematic parameters (e.g., speed, acceleration, jerk, momentum, etc.); vehicle location (e.g., vehicle location measurement); vehicle location accuracy distance or range (e.g., GPS accuracy, horizontal GPS accuracy, vertical GPS accuracy, etc.); location type and/or classification of the path on which the vehicle is operating, such as the roadway type (e.g., residential road, multi-lane road, highway, bike lane, bike path, sidewalk, pedestrian path, unpaved trail, not a designated roadway or path, etc.); vehicle pose parameters (e.g., vehicle orientation, vehicle direction of motion, rotation (e.g., yaw, pitch, roll, etc.), etc.); vehicle class (e.g., light vehicle, truck, personal vehicles, etc.); ambient environment, such as riding surface quality (e.g., presence and/or extent of cracks and/or potholes; surface characteristics such as wet, icy, loose, etc.); weather (e.g., precipitation such as rain, visibility, vehicle performance factors such as temperature, etc.); road state (e.g., presence and/or extent of cracks and/or potholes; surface characteristics such as wet, icy, loose, etc.); proximity to other vehicle (e.g., cars, trucks, vans, other light vehicles, etc.; as determined from images, short-range communications, etc.); proximity to pedestrians; trip parameters (e.g., origin, destination, route, time, primary geographic regions intersected, etc.); driving session (e.g., activated, deactivated, etc.); geographic parameters (e.g., current geographic location or region, trip origin, trip destination, etc.); vehicle condition parameters (e.g., state of charge, maintenance codes, error codes, total miles travelled, wheel wear, brake wear, motor power output, etc.); user parameters; and/or any other suitable information. The vehicle operation parameters are preferably a time series of information, but can additionally or alternatively be a single value dataset, a derivative dataset (e.g., determined from the sampled vehicle measurements, such as the average velocity or battery discharge rate), and/or take on any suitable data structure form.

The user parameters can include: mass, height, weight distribution, number of vehicle users (e.g., 1 user, 2 users, more than 2 users, etc.; within or above a user capacity; etc.), safety gear (e.g., presence or absence thereof; as determined from inward-facing cameras, short range communications with the safety gear, etc.), user profile, user ride history (e.g., first-time vehicle user, experienced user, user typically exhibiting safe or unsafe behavior, user previously responsible for vehicle damage, user who has completed a vehicle safety and/or operation instruction course, etc.), user intoxication level (e.g., blood alcohol content (BAC)), alertness level, operation style (e.g., exhibiting unsafe characteristics, such as swerving, high-intensity braking, non-adherence to traffic laws, etc.; exhibiting safe characteristics; etc.), user experience, and/or any other suitable factor.

In specific embodiments of the invention, vehicle operation conditions can include: setting a speed limit, such as a maximum speed (e.g., fraction of the standard maximum speed, such as 90%, 75%, 50%, 25%, 100-80%, 80-50%, 50-30%, 30-10%, 10-1%, etc.; less than the standard maximum speed by an absolute amount, such as 1, 2, 3, 5, 7.5, 10, 15, 20, 25, 0-2, 2-5, 5-10, 10-20, or 20-30 mph, absolute speed value, etc.) or a minimum speed for vehicle operation (e.g., 5 mph, 3 mph, 1 mph, 0.5 mph, etc.); geographic location based restrictions (e.g., no-vehicles allowed zones, no vehicle parking zones, setting limits for the number of vehicles that can park in a zone, no-exit zones), location type restrictions (e.g., maximum speed depends on the location type, such as bicycle lane, sidewalk, boardwalk, bicycle path, etc.); safety gear (e.g., mandatory helmet wearing, blood alcohol level must be below a threshold, such as <0.02%, lights must be engaged at night, light must be used at all times, etc.); weather (e.g., maximum speed lowered in low visibility conditions, such as rain, fog, snow, etc.); user parameters (e.g., must be above a certain age, such as 16, 18, etc.; must possess a valid driver's license; no more than 1 user at a time; etc.); but can additionally or alternatively include any suitable vehicle operation conditions.

The vehicle operation responses are preferably vehicle operation instructions that apply when the vehicle operation parameter meets the vehicle operation conditions. Additionally or alternatively, vehicle operation responses can include implementing fines, presenting client notifications, changing user parameters (e.g., user profile, user history, etc.), remapping the vehicle throttle (e.g., to a higher or lower output), remapping the power response curve, capping the vehicle operation parameter (e.g., limiting the vehicle speed), or otherwise adjusting the vehicle operation responses. A vehicle operation response can preferably be correlated with one or more vehicle operation conditions, one vehicle operation response can correspond to one vehicle operation condition, one vehicle operation response can correspond to multiple vehicle operation conditions, multiple vehicle operation responses can correlate to a vehicle operation condition, and/or vehicle operation responses can be applied in any suitable manner. In specific embodiments where the vehicle operation condition corresponds to one or more vehicle operation responses, the vehicle operation responses can be associated with an assigned order, be associated with a set of sub-conditions (e.g., that determine the priority for each response), be performed concurrently, or be performed in any suitable order.

In specific embodiments of the invention, vehicle operation responses can include: kinematic responses (e.g., ramp up vehicle operation parameters, such as increasing vehicle speed; ramping down vehicle operation parameters, such as decreasing vehicle speed; limiting vehicle operation parameters, such as restricting motor power output; controlling the vehicle steering system; etc.); notification responses (e.g., alerting the user to new vehicle operation conditions, impending response application, warning messages, etc.), such as visually (e.g., on a display, with warning lights, etc.), aurally (e.g., alarms), tactilely (e.g., vibration), or via another output; providing suggestions to the user (e.g., alternate routes, offer trip termination, etc.); controlling auxiliary vehicle systems (e.g., lights, sounds, etc.); user activity responses (e.g., preventing the user from disabling the vehicle, such as by precluding trip termination, precluding the vehicle speed from falling below a threshold speed, precluding the user from enabling the vehicle, charging the user penalty fees, such as a flat fee, fee depends on violation, fee depends on user history, etc.); modifying the user profile (e.g., updating the user history, providing points/rewards to user, providing user discounts, etc.); changing the primary geographic region (e.g., increasing/decreasing the area encompassed by the geographic region, increasing/decreasing the numerosity of geographic regions, etc.); overriding one or more vehicle operation responses (e.g., changing the default response, changing the higher-order responses, etc.); changing the frequency that vehicle operation parameters are sampled (e.g., increasing the sampling rate of vehicle operation parameters); and/or any suitable vehicle operation responses. In a specific embodiment, alert warning messages may include “toll free,” “no riding on sidewalks,” “compliance with laws,” “age requirements,” and “no passengers.”

In one example of vehicle operation rules, when vehicle operation conditions are satisfied depending on a desired roadway type (e.g., bike lane or bike path), then the vehicle operation response can be to allow vehicle operation parameter to operate up to a standard maximum speed (e.g., unless another, more restrictive vehicle operation rule also applies), such as a maximum design speed and/or maximum speed allowed for normal vehicle operation. In contrast, when the vehicle operation conditions are not satisfied, such as when the vehicle is operating on a roadway type other than the permitted roadway types (e.g., undesired roadway type, such as sidewalk, pedestrian path, highway, not a designated roadway or path, etc.), then the vehicle operation responses can restrict vehicle operation parameters, such as to limit the vehicle's maximum speed to an amount less than the standard maximum speed (e.g., fraction of the standard maximum speed, such as 90%, 75%, 50%, 25%, 100-80%, 80-50%, 50-30%, 30-10%, 10-1%, etc.; less than the standard maximum speed by an absolute amount, such as 1, 2, 3, 5, 7.5, 10, 15, 20, 25, 0-2, 2-5, 5-10, 10-20, or 20-30 mph, etc.). Additionally or alternatively, the set of vehicle operation rules can include restricting operation of vehicles for which all or some of the designated safety criteria are not satisfied (preferably, for which any one or more of the designated safety criteria are not satisfied). Such restrictions can include, for example, restricting the vehicle's maximum speed (e.g., as described above), restricting vehicle operation parameters on certain roadway types (e.g., limited operation time on bike lanes and roads, such as limited to no more than 60 seconds in a 10 minute interval), and/or restricting vehicle operation in any other suitable manner.

In another example of vehicle operation rules, a set of vehicle operation conditions can include meeting a set of one or more designated safety criteria (or a subset thereof) (e.g., vehicle user is wearing a helmet; vehicle user BAC<threshold (e.g., 0.02%); the vehicle user capacity is not exceeded, such as in use by only one user; the vehicle is not being operated in an unsafe manner that includes substantial swerving behavior; etc.). If the vehicle operation conditions are met, then vehicle operation response can include the vehicle operation parameters can be modified (e.g., the trip can be initiated). If the vehicle operation parameters are not met (e.g., vehicle user is not wearing a helmet, vehicle user BAC>threshold (e.g., 0.02%), the vehicle user capacity is exceeded (e.g., use by more than 1 user), the vehicle is being operated in an unsafe manner (e.g., a manner that includes substantial swerving behavior), etc.), then the vehicle operation response can include preventing the vehicle operation parameters from being modified (e.g., the trip cannot be initiated). Additionally or alternatively, violating the set of vehicle operation conditions can include restricting the vehicle operation parameters (e.g., vehicle speed, trip duration, etc.), updating the user parameters (e.g., user ride history, user profile, etc.), charging the user a fine, and/or applying any other suitable restriction.

In another example of vehicle operation rules, a set of vehicle operation conditions depends on the external environment conditions (e.g., weather, time of day, visibility, etc.). When the vehicle operation conditions are favourable (e.g., sunny, daytime, good visibility, etc.), the vehicle operation responses can include allowing vehicle operation parameters to operate in favorable conditions, such as at a maximum design speed and/or maximum speed for normal vehicle operation. If the vehicle operation conditions are unfavourable (e.g., cloudy, rainy, windy, snowy, nighttime, foggy, poor visibility, etc.), them the vehicle operation responses can include limiting vehicle operation parameters (e.g., limiting speed (as described above), restricting trip intiation, etc.), requiring operation of safety features (e.g., lights, sounds, etc.), and/or can include another other restriction suitable for the environmental conditions.

In some embodiments, one or more vehicle operation rules may concurrently apply to a particular vehicle. In such cases, the most restrictive vehicle operation rules (and/or subsets thereof) preferably take precedence (e.g., for a first vehicle operation rules dictating a first maximum speed and a second vehicle operation rules dictating a second maximum speed less than the first, a vehicle matching the criteria of both the first and second vehicle operation rules would be subject to the second maximum speed). Additionally or alternatively, the vehicle operation rules can be associated with precedence values (e.g., rankings, scores, etc.), wherein the greatest-precedence rule applies, Additionally or alternatively, the multiple vehicle operation rules can be assigned an order, wherein the rule enforcement order can be predetermined, be determined based on the vehicle operation parameters, be determined based on the vehicle operation context, or be otherwise determined. However, concurrent satisfaction of the criteria associated with multiple rules can additionally or alternatively be handled in any other suitable manner.

In some embodiments, the number of vehicle operation rules may depend on the vehicle operation parameters, user parameters, vehicle condition parameters, and/or be determined in another suitable manner.

### 4.1.1 Primary Geographic Region Vehicle Operation Rules.

In one variant of the method S10, the vehicle operation rules can depend on a primary geographic region 120 that the vehicle is operated within. Having vehicle operation rules that depend on the primary geographic region 120 that the vehicle is operated in functions to associate vehicle operation parameters with a given geographic location and enables the specific vehicle operation rules to be determined in that geographic location.

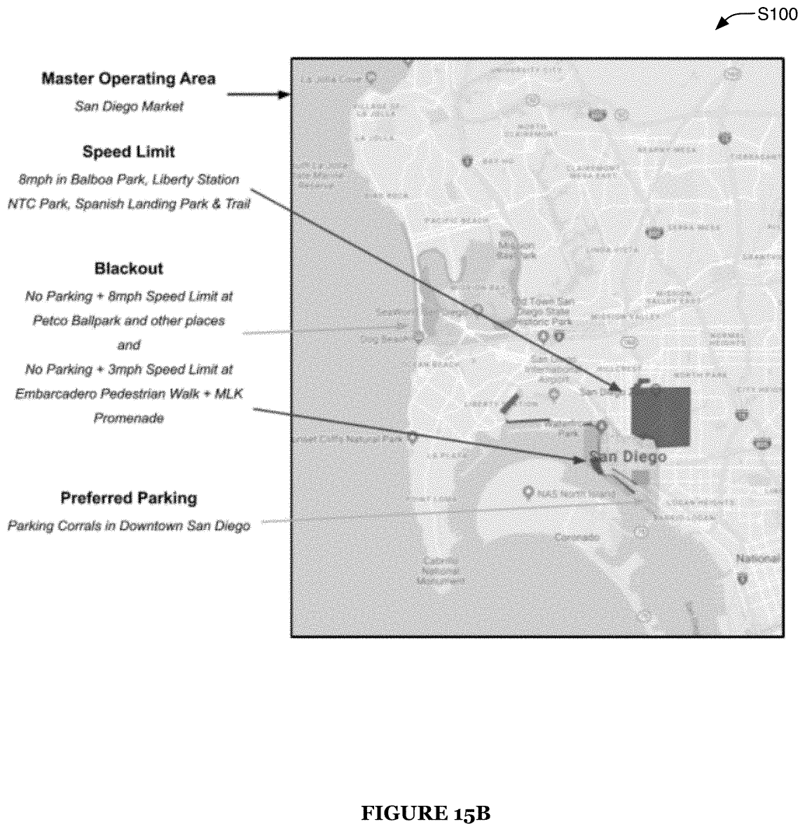

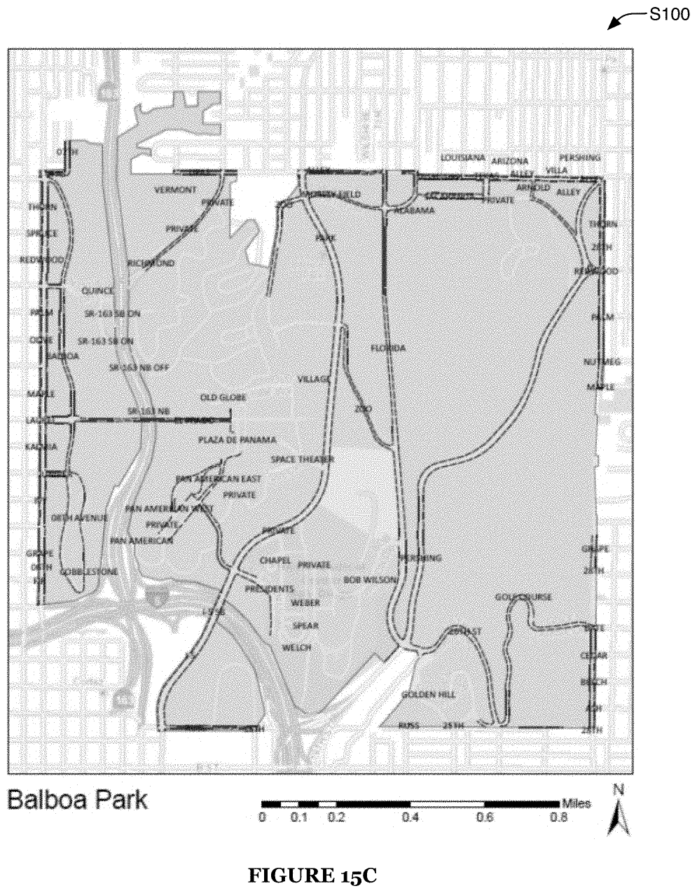

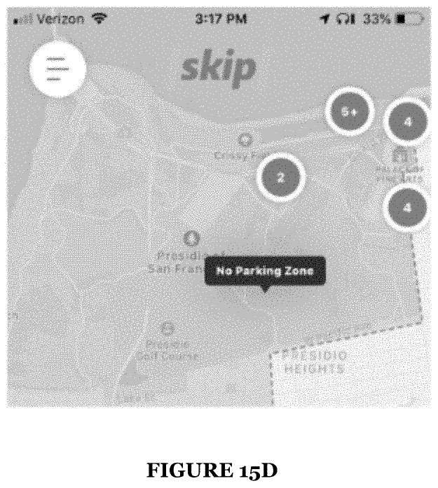

The primary geographic region 120 is preferably associated with a predetermined set of vehicle operation rules (e.g., for example as shown in FIGS. 15A-15D), but can additionally or alternatively be associated with a dynamic set of vehicle operation rules, changing set of vehicle operation rules, and/or any other suitable vehicle operation rules. The primary geographic region vehicle operation rules are preferably implemented by the control system 220 of the vehicle, but can additionally or alternatively be implemented by a user device, external computing system 400, vehicle, manually, and/or by any other suitable system.

The primary geographic region 120 can be a predetermined geospatial area such as: a municipality or administrative division (e.g., country, state, county, parish, city), a government-defined geographic area (e.g., parks, neighborhoods, districts, school zones, points of interest, zoos, stadiums, etc.), an event area (e.g., parade route, construction zone, emergency zone, etc.), a user-defined geographic area, a venue, or any other suitable geospatial area. However, the primary geographic region 120 can additionally or alternatively include region(s) associated with (e.g., within a threshold distance of, encompassing, etc.): positions (e.g., geospatial coordinates), linear and/or curvilinear segments (e.g., defined by geospatial coordinates and/or curved segment parameters), city blocks, address ranges, and building types (e.g., schools, senior centers, hospitals, fire stations, police stations, etc.). The primary geographic regions can additionally or alternatively include any arbitrarily defined geographic region and/or any other suitable regions.

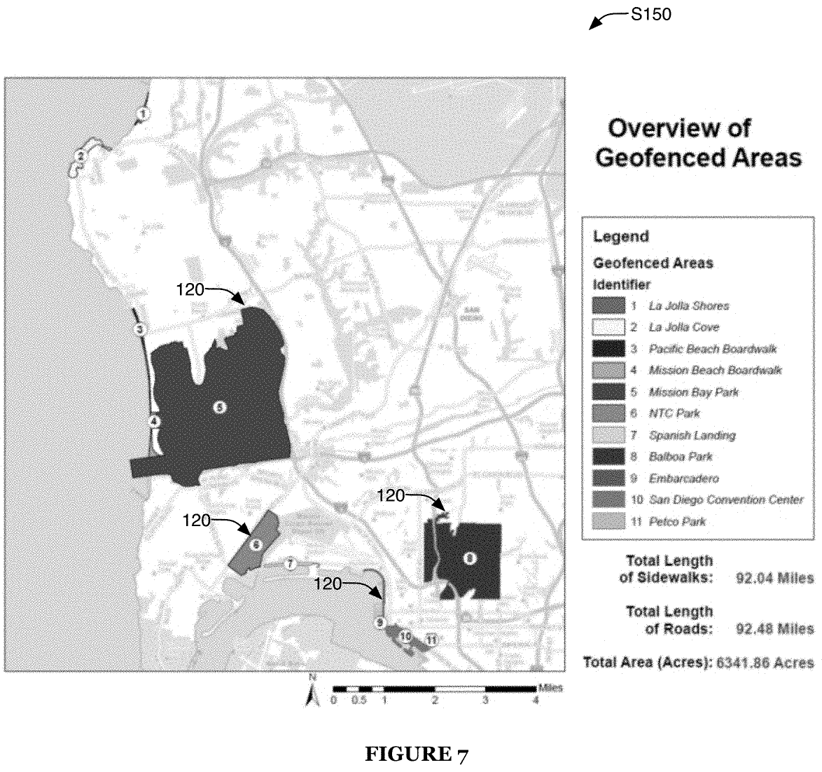

The primary geographic region 120 is preferably delineated by one or more geofences (e.g., example as shown in FIG. 7). Alternatively, the primary geographic region 120 can be separated into geographic subunits (e.g., 1 square meter, a 5×5 m unit, circle with radius 1 meter, etc.). Additionally or alternatively, the primary geographic region can be delineated in any other suitable manner. In specific examples, the geofence can include one or more shapes such as polygons (e.g., defined by coordinates of vertices, curved segment parameters such as spline parameters, shape parameters such as conic section parameters and/or polygon parameters, masks and/or bitmaps, etc.), circles, hand-drawn, have an arbitrary shape, have an arbitrary granularity, be defined based on surrounding geofences, be defined based on connected authorized road types, and/or be any suitable shape. In some embodiments, the one or more geofences can overlap, be separate and distinct, be nested, be adjacent, or be otherwise related.

The primary geographic region 120 is preferably determined S150 prior to determining the primary geographic region rules, but can additionally or alternatively be determined simultaneously with, after, or based on the primary geographic region rules. The primary geographic region is preferably determined by the processing system of the computing system 200 (e.g., of the vehicle), but can additionally or alternatively be determined by the user device 300, the vehicle 100, an external computing system 400, or by any other suitable system. The primary geographic region is preferably retrieved from local memory on the vehicle, but can additionally or alternatively be determined from external memory (e.g., retrieved from a database or cloud storage), determined from a user device, dynamically generated (e.g., based on an events calendar, when an external server connects to the vehicle to update the primary geographic region, etc.), computer vision (e.g., identifying an area based on signs, identifying an area based on context, etc.), learning algorithms (e.g., via computer learning based on previous user experiences in a region, based on a user population's behavior, such as behavior of “good” users, etc.), manually entered (e.g., regions on a map drawn by vehicle users, regions on a map selected by community members, etc.), and/or any suitable manner for identifying primary geographic regions. The primary geographic region 120 (and/or associated rules) is preferably determined upon vehicle ride engagement (e.g., initiation of a vehicle operation session, ride session, etc.), but can additionally or alternatively be determined dynamically (e.g., based on vehicle operation parameters, user parameters, instantaneous vehicle location, etc.), when the vehicle crosses the primary geographic region boundary, periodically (e.g., at a predetermined frequency, with a client-determined frequency, based on distance to the primary geographic region boundary, etc.), continuously updating, updated based on vehicle operation parameters (e.g., anytime the vehicle stops, anytime vehicle motion starts, etc.), and/or at any other suitable timing.

Each primary geographic region 120 (and/or geographic subunit thereof) can be associated with one or more vehicle operation rules. The vehicle operation rules associated with each geofence can be: received from a user, determined based on municipal regulations, determined based on the rules for the other geofences (e.g., an outer geofence vehicle operation rules can be determined based on an inner geofence vehicle operation rules, an overlapping geofence region can have an average of the overlapping geofence vehicle operation rules or have a hierarchy of vehicle operation rules, a geofence's rules can be determined based on adjacent geofences' rules, etc.), be independent of the vehicle operation rules for adjacent geofences, and/or be determined in any other suitable manner.

In one example, a set of vehicle operation rules is associated with a primary geographic region. Within this region, vehicle operation conditions can include restrictions to vehicle operation parameters (e.g., a maximum vehicle speed, a minimum vehicle speed, etc.). When the vehicle operation parameters are within the acceptable vehicle operation conditions (for the primary geographic region) (e.g., there are no other vehicle operation rules that need to be fulfilled, speed is below the maximum speed, vehicle speed is above minimum vehicle speed, etc.), then the vehicle operation response can include no further action being taken, include user operating parameters being updated (e.g., updating user profile, updating user history, etc.), include alerting user to the vehicle operating conditions, and/or any suitable vehicle operation response. When the vehicle operation parameters are outside of the acceptable vehicle operation conditions (e.g., the vehicle speed is greater than the maximum vehicle speed, the vehicle speed is less than the minimum vehicle speed, etc.), then the vehicle operation response can include alerting the user to the primary geographic region vehicle operation conditions (e.g., using an alarm, display, etc.), automatically updating vehicle operation parameters to within acceptable values (e.g., automatically reducing the vehicle speed by remapping the throttle to lower output, reducing the vehicle speed by applying the brakes, reducing the vehicle speed by decreasing power output, increasing speed by remapping the throttle to higher output, etc.).

In another example, as shown in FIG. 11, a set of vehicle operation rules associated with a primary geographic region can include vehicle restrictions (e.g., no vehicle parking, no vehicle entry, etc.). In this example, the vehicle operation response can include: alerting the user to the vehicle operation conditions (e.g., display, alarm, etc.) when the vehicle is within the primary geographic region or within a predetermined distance of the primary geographic region, modifying vehicle capabilities (e.g., prevent trip termination, reducing speed to o at the primary geographic region boundary, etc.), or otherwise modifying or limiting vehicle capabilities.

In another example, as shown in FIG. 12, a set of vehicle operation rules associated with a primary geographic region can include vehicle operation conditions that modify vehicle operation based on the presence of other vehicles (e.g., enforcing a maximum number of vehicles that can be parked in a primary geographic region, within the vicinity of other vehicles, etc.). In this example, the vehicle operation response can include: alerting the user to the vehicle operation conditions (e.g., using a display, alarm, etc.), checking for other vehicles 100 in the primary geographic region 120 (e.g., using vehicle to vehicle communication, using an image of the geographic area around the vehicle, etc.), modifying vehicle operation parameters (e.g., preventing trip termination, reducing vehicle speed to 0 at the primary geographic region boundary, etc.) when the number of vehicles 100 in the primary geographic region 120 exceeds the maximum number of vehicles 100, or otherwise controlling vehicle operation based on the number of vehicles within the primary geographic region.

In another example, a set of vehicle operation rules associated with a primary geographic region can include vehicle operation conditions that depend on the road type (e.g., sidewalks, bike lanes, etc.). In this example, the vehicle operation response can include: alerting the user to the vehicle operation conditions (e.g., display, alarm, etc.), modifying the vehicle speed (e.g., reducing the maximum vehicle speed to a fraction of the standard maximum speed, such as 90%, 75%, 50%, 25%, 100-80%, 80-50%, 50-30%, 30-10%, 10-1%, etc.; reducing the allowable vehicle speed to less than the standard maximum speed by an absolute amount, such as 1, 2, 3, 5, 7.5, 10, 15, 20, 25, 0-2, 2-5, 5-10, 10-20, or 20-30 mph etc.; limiting the vehicle speed to a fixed value such as 0, 3, 5, 8, 10, mph etc.; etc.) when vehicles 100 in the primary geographic region 120 are operated on restricted road type, modifying user operating parameters (e.g., updating user history, adding points/rewards/discounts for operating on proper road surfaces, charging fees for operating on inappropriate road surfaces, etc.). Additionally or alternatively, the vehicle operation response can include any suitable response.

Vehicle operation rules associated with primary geographic regions can optionally be associated with vehicle pose (e.g., direction of travel, origin and destination, route, etc.; example as shown in FIG. 6). For example, a rule may only apply (and/or apply differently) to vehicles 100 entering the primary geographic region 120 from outside said primary geographic region (and/or to vehicles 100 that began travel within the primary geographic region 120), vehicles 100 traveling in a particular direction or range of directions (e.g., vehicles 100 with average velocities oriented between two compass headings, such as velocities oriented between Northward and Westward), vehicles 100 traveling toward the primary geographic region 120 (e.g., the current vehicle trajectory would intersect the primary geographic region if the trajectory is not changed), the probability that the vehicle route will intersect and/or end in the primary geographic region (e.g., probability associated with the vehicle's instantaneous position, determined based on the historical probability of riders within the given geographic unit intersecting or ending at the primary geographic region 120, etc.); the probability associated with the origin/destination of entering and/or terminating within the primary geographic region, the probability associated with the user (e.g., based on user history), etc.) of entering and/or terminating within the primary geographic region, the component of the vehicle heading directed toward the primary geographic region (e.g., wherein the rule is applied when the radial heading component is larger than a predetermined multiple of the tangential heading component; wherein the rule is not applied when the tangential or normal heading component exceeds the radial heading component; etc.), and/or vehicles 100 with any other suitable travel directions.

In an example of a vehicle operation rule that depends on a primary geographic region and vehicle direction of motion, if a route is determined (e.g., user enters origin and destination, based on the probability of the route, etc.) that crosses a primary geographic region with restrictions (e.g., no vehicles allowed, reduced speed, etc.), then one or more alternate routes (e.g., travelling around the primary geographic region) can be determined and suggested to the user.

In an example of a vehicle operation rule that depends on a primary geographic region and vehicle direction of motion, the vehicle operation rules can be selectively applied based on the route origin and destination. For example, the vehicle operation rules can be associated with different legs/segments of the route. The vehicle operation rules for each leg/segment can be determined based on the vehicle operation rules for each leg/segment's current geographic region (e.g., a primary geographic region encompassing the leg/segment's geographic location), the rules for subsequent leg/segment's primary geographic region, or otherwise determined. In this example, the vehicle operation rules can be set at the start of the trip and not updated, be dynamically updating (e.g., if the vehicle location is tracked during the trip and the vehicle follows a different route than initially determined), and/or be otherwise determined during the vehicle operation.

### 4.1.2 Secondary Geographic Region Vehicle Operation Rules.

The method can optionally include determining a secondary geographic region associated with a secondary set of rules. This secondary geographic region can function as a buffer zone for gradual vehicle operation transition (e.g., by gradually modifying the vehicle operation parameters) to the primary geographic region's operation conditions.

The secondary geographic region 140 is preferably determined prior to determining the secondary geographic region rules, but can additionally or alternatively be determined simultaneously with, after, or based on the secondary geographic region rules. The secondary geographic region 140 is preferably determined by the processing system of the computing system, but can additionally or alternatively be determined by the user device 300, the vehicle 100, an external computing system 400, or by any other suitable system.

The secondary geographic region 140 is preferably determined at the same time as the primary geographic region, but can additionally or alternatively be determined dynamically (e.g., based on vehicle operation parameters, user parameters, etc.), as the vehicle crosses the primary geographic region boundary (e.g., entering, exiting, etc.), statically (e.g., stored at the start of the ride), periodically (e.g., with a client determined frequency, based on distance to the primary geographic region boundary, etc.), continuously updating, depending on vehicle operation parameters (e.g., anytime the vehicle stops, anytime vehicle motion starts, etc.), at a time unrelated to the determination of the primary geographic region, and/or at any other suitable timing.

The secondary geographic region 140 is preferably retrieved from local memory on the vehicle, but can additionally or alternatively be determined from external memory (e.g., retrieved from a database or cloud storage), determined from a user device, dynamically generated (e.g., based on an events calendar, when an external server connects to the vehicle to update the primary geographic region, etc.), computer vision (e.g., identifying an area based on signs such as: park; boardwalk; etc., identifying an area based on context such as: farmer's market; festival; etc., etc.), learning algorithms (e.g., via computer learning based on previous user experiences in a region, based on a user population's behavior, such as behavior of “good” users, etc.), manually entered (e.g., regions on a map selected by vehicle users, regions on a map selected by community members, etc.), based on an equation (e.g., an equation that takes into account the vehicle speed, a slowing distance, primary geographic region, primary geographic region rules, etc), and/or any suitable manner for identifying primary geographic regions.

The secondary geographic region is preferably determined based on a primary geographic region, but can additionally or alternatively be defined similarly to primary geographic region definition, or be otherwise defined. The secondary geographic region is preferably automatically determined based on the primary geographic region (e.g., the primary geographic region's shape, location type, rules, etc.), but can additionally or alternatively be manually determined (e.g., received from a user), or otherwise determined.

For example, the secondary geographic region can have the same shape as the primary geographic region, concentrically surround the primary geographic region (e.g., circle that circumscribes the primary geographic region; circle that circumscribes the primary geographic region plus a given distance such as: 100 ft, 250 ft, 500 ft, etc.; polygon that circumscribes the primary geographic region; etc.), asymmetrically surround the primary geographic region, surround the primary geographic region a fixed distance from the primary geographic region boundary (e.g., 100 ft, 250 ft, 500 ft, etc.), surround part of the primary geographic region (e.g., when the geographic region is partially bounded by an inaccessible barrier such as: a body of water, gorge, restricted access roads, etc., the secondary geographic region 140 only surrounds the primary geographic region on the accessible sides), overlap with the primary geographic region, be based on the road types adjacent to the primary geographic region (e.g., when the roads are more damaged/have more traffic/lower average speed/etc. the secondary geographic region is closer to the primary geographic region; more sidewalks/less traffic/higher average speeds/etc. the secondary geographic region is further from the primary geographic region), depend on the vehicle speed (e.g., be determined as a function of difference in vehicle speed limit between the secondary geographic region and primary geographic region, be larger when the vehicle speed is larger, examples shown in FIG. 9, etc.), depend on the primary geographic region rules (e.g., size depending on the primary geographic region speed limit), depend on uncertainty and/or inaccuracy in sensor measurements (e.g., be larger when the noise in the location measurement is larger), etc. Additionally or alternatively, the secondary geographic region can have an arbitrary shape, be unrelated to the primary geographic region, can be defined in the same manner as the primary geographic region (e.g., as described above), and/or have any suitable shape or relationship to the primary geographic region.

The secondary geographic region is preferably static (e.g., have a fixed size and/or shape), but can additionally or alternatively be dynamic (e.g., change based on vehicle operation parameter, weather, user parameter, etc.), or be otherwise configured. The boundary type (e.g., static or fuzzy) for the secondary geographic region preferably matches the boundary type for the primary geographic region (e.g., if the primary geographic has a static boundary the secondary geographic region also has a static boundary). Alternatively or additionally, the boundary for the secondary geographic region can be different from the primary geographic region and/or be defined in any suitable manner.

The secondary geographic region 140 can have the same shape as the primary geographic region (e.g., be a larger or smaller version of the primary geographic region), or have any suitable shape. Examples of secondary geographic region's shape include: polygons (e.g., defined by coordinates of vertices, curved segment parameters such as spline parameters, shape parameters such as conic section parameters and/or polygon parameters, masks and/or bitmaps, etc.), circles, hand-drawn, arbitrary shapes, arbitrary granularity, and/or any suitable shape.

In a first example, the secondary geographic region boundary can be the primary geographic region boundary increased by a predetermined distance. In a second example, the secondary geographic region's boundary surrounds and is at least a predetermined distance away from the primary geographic region's boundary, wherein the shape of the secondary geographic region can be defined by roads permitting the vehicle type and/or adjacent primary geographic regions' rules. The predetermined distance can be determined based on: the difference between the vehicle's current speed and the speed permitted within the primary geographic region; the difference between the maximum vehicle speed and the speed permitted within the primary geographic region; the vehicle direction of motion (e.g., entering or exiting the primary geographic region); uncertainty in sensor signals (e.g., GPS noise); or otherwise determined.

A primary geographic region 120 can be associated with one or more secondary geographic regions 140. The secondary geographic regions 140 can: surround the primary geographic region, be nested within the primary geographic region, be arranged adjacent to, overlap with, be proximal to, have no relationship to the primary geographic region, and/or be otherwise suitably defined.

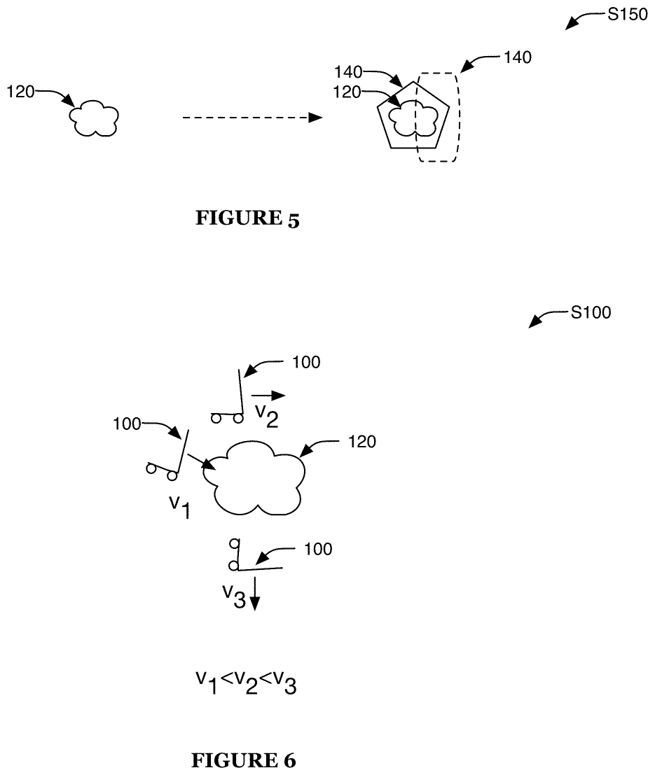

Multiple secondary geographic regions 140 can be arranged in any suitable manner, such as: concentrically around one another, non-overlapping with each other, overlapping with each other, have an arbitrary relationship to each other, have no relationship to each other, be adjacent to each other, be separate and distinct, and/or have any suitable arrangement, examples shown in FIG. 5. In specific examples, the secondary geographic regions can have the same shape, have different shapes, a subset can have the same shape and a subset have different shapes, can be any suitable shape as defined above, cover the same effective surface area, and/or be otherwise suitably defined.

The secondary geographic region 140 is preferably associated with a predetermined set of vehicle operation rules, but can additionally or alternatively be associated with a dynamic set of vehicle operation rules, changing set of vehicle operation rules, and/or any other suitable vehicle operation rules. The secondary geographic region vehicle operation rules are preferably determined concurrently with the determination of the secondary geographic region, but additionally or alternatively can be determined before or after determining the secondary geographic region. The secondary geographic region vehicle operation rules are preferably determined concurrently with the primary geographic region vehicle operation rules, but additionally or alternatively can be determined before or after determining the primary geographic region vehicle operation rules.

The secondary geographic region vehicle operation rules preferably function to smooth the transition to the primary geographic region vehicle operation rules, to provide a smooth ride for the user.

The secondary geographic region vehicle operation rules (secondary rules) are preferably defined based on the primary geographic region's vehicle operation rules (primary rules), but can alternatively be independent of the primary geographic region vehicle operation rules, determined based on historical riding patterns for the secondary geographic region, or otherwise determined. The secondary rules preferably gradually transition (e.g., linearly, exponentially, logarithmically, etc.) the vehicle to the primary rule conditions (e.g., gradually transition the vehicle speed to the primary rule's speed limit), but can be otherwise configured.

The secondary rule can be determined based on: the primary rules (e.g., primary rule values), the distance between the secondary geographic region (and/or rule location) and the primary geographic region, the instantaneous vehicle operation parameters (e.g., kinematics, such as speed or acceleration; rider weight; etc.), the riding context (e.g., weather, traction, road conditions, etc.), and/or any other suitable variable.

The secondary rules are preferably subordinate to the primary rules (e.g., primary rules have priority over the secondary rules), but can additionally or alternatively have equal or greater weight than the primary rules, and/or have any suitable weight/preference.

In a first variation, the secondary rules can be calculated from the primary rules using an equation (e.g., a linear equation, logarithmic function, etc.). In an example of the first variation, the secondary rules can be a function of the vehicle's current speed, the vehicle's maximum speed, the vehicle's target speed (e.g., from the secondary rules, primary rules, etc.), the vehicle's maximum acceleration, the vehicle's maximum deceleration, a target vehicle acceleration/deceleration, and/or any other suitable parameter. In a second variation, the secondary rules can be a reaction (e.g., wherein the secondary rules are defined as a reaction to the action that would be taken based on the primary rules). In a third variation, the secondary rules can be determined using a look-up table, conditional statements, and/or defined in any suitable manner.

When the system includes multiple secondary geographic regions 140, the secondary geographic region rules can be: determined based on the rules for the other secondary geographic regions 140 (e.g., adjacent secondary regions' rules), be independent of the vehicle operation rules for adjacent secondary geographic region, and/or be determined in any other suitable manner. For example, an outer secondary geographic region's rule can be determined based on an inner secondary geographic region's rule(s); an overlapping secondary geographic region can have an average of the overlapping secondary geographic region vehicle operation rules or have a hierarchy of vehicle operation rules, or have any suitable set of rules.

In a first specific example, the secondary geographic region 140 encompasses (e.g. surrounds) the primary geographic region. The primary geographic region is associated with a set of primary rules specifying a speed limit (e.g., applied when the vehicle is located within the primary geographic region). In this example, the secondary geographic region is associated with a set of secondary rules specifying a speed limit greater than the speed limit in the primary geographic region, but less than the maximum vehicle speed. When the vehicle is located within the secondary geographic region 140 and traveling with a speed greater than the secondary geographic region speed limit, the vehicle will automatically slow down (e.g., by remapping the throttle, limiting motor output, applying the brakes, etc.). When the vehicle enters the primary geographic region, then the vehicle is speed is decreased further until the vehicle speed reaches the primary geographic region speed limit (e.g., as described above).

In a second specific example, the secondary geographic region vehicle operation rules include a set of speed limits that decrease with proximity to the primary geographic region. In this specific example, the speed limits can decrease continuously as the proximity to the primary geographic region decreases. Alternatively, the system can include a series of nested secondary geographic regions, wherein each secondary geographic region is associated with a different speed limit (e.g., decreasing with proximity to the primary geographic region). For example, the inner secondary geographic regions have speed limits closer to the primary geographic region than the outer secondary geographic regions.

In a third specific example, the secondary geographic region vehicle operation conditions (e.g., speed limit) are a function of the vehicle distance from the primary geographic region. In this example, the secondary geographic region vehicle operation response (e.g., speed limit enforcement) is a function of the vehicle operation parameter (e.g., current vehicle speed) and the secondary geographic region vehicle operation conditions (e.g., target speed limit).

In a fourth example, the secondary geographic region vehicle operation conditions can be determined based on the direction of vehicle motion. In a first variation, the vehicle heading determines secondary rule application. For example, the secondary geographic region response can be selectively applied if the vehicle direction of motion is toward the primary geographic region (e.g., predicted to intersect the primary geographic region, etc.), and may not apply if the vehicle direction of motion is not toward the primary geographic region. In a second variation, the vehicle heading can be used to determine the secondary response (e.g., used to determine the target speed within the secondary geographic region). For example, the target speed can be scaled with the proportion of the radial component of the heading vector (e.g., intersecting the primary geographic region) relative to the normal component of the heading vector. Alternatively, the secondary geographic region responses can be partially applied (e.g., an intermediate speed limit between the maximum vehicle operation speed and the speed limit for a vehicle the same distance from the primary geographic region, but traveling in a direction of motion predicted to intersect the primary geographic region, may be applied) if the vehicle direction of motion is not toward the primary geographic region (e.g., based on the angle between a head on trajectory toward the primary geographic region and the current vehicle trajectory, based how close the current vehicle trajectory is predicted to come to the primary geographic region, etc.), and/or may apply in any suitable manner.

In a fifth example, the primary geographic region vehicle operation rules include a primary geographic region vehicle operation condition, prohibiting vehicles 100 from being parked in the primary geographic region. In this example, the secondary geographic region rules can include alerting the user to the upcoming parking restricted area (e.g., visually, aurally, haptically, etc.) and suggesting to the user that they terminate the ride outside the primary geographic region (e.g., in the secondary geographic region). The rules can optionally include slowing the vehicle to a predetermined speed (e.g., 0 mph) a predetermined distance away from the primary geographic region.

In a sixth example, the primary rules include a vehicle restricted area (e.g., no vehicles allowed in the primary geographic region). In this example, the secondary rules can depend on vehicle direction of travel and can include alerting the user to the upcoming vehicle restricted zone (e.g., visually, aurally, haptically, etc.), decreasing the vehicle speed (e.g., applying the brakes, remapping the throttle, etc.), precluding the user from turning toward the primary geographic region (e.g., locking the steering mechanism), and/or any other suitable rules. In this example, the secondary geographic region can include an outer secondary geographic region(s) and an inner secondary geographic region(s). In this example, the conditions for the outer secondary geographic region can depend on the vehicle direction of travel (e.g., directed toward the primary geographic region, predicted to intersect the primary geographic region, etc.). In the outer secondary geographic region, the vehicle speed can be limited when the vehicle is directed toward the primary geographic region, but can be unrestricted if the vehicle is not traveling toward the primary geographic region. Additionally or alternatively, any suitable number of secondary geographic regions can be defined associated with any appropriate secondary geographic region rules.

In a seventh example, the secondary rules can be determined based on the current weather within the secondary geographic region. The weather can be: determined by the vehicle (e.g., based on on-board ambient environment sensors), retrieved from a weather database for the vehicle's location, or otherwise determined. The secondary rules can be: maintained, scaled, or otherwise modified based on the weather. For example, the speed limit in the secondary geographic region can be decreased when rain is present or forecasted for the geographic region. However, the secondary rules can be otherwise determined.

### 4.2 Determine Vehicle Operation Parameters.

Determining vehicle operation parameters S200 preferably functions to determine information related to the vehicle operation rules. The vehicle operation parameters can be determined for one or more vehicles 100. The vehicle operation parameters are preferably determined after the vehicle operation rules are determined, but can additionally or alternatively be determined before the vehicle operation rules, concurrently with the vehicle operation rules, and/or at any suitable time. The vehicle operation parameters are preferably as described above, but can additionally or alternatively be any suitable information. A vehicle is preferably described by one or more vehicle operation parameters, but additionally or alternatively a fleet of vehicles (e.g., 1 or more vehicles) can be described by vehicle operation parameters, a class of vehicles can be described by vehicle operation parameters, and/or any suitable vehicle to vehicle operation parameters can apply.

The vehicle operation parameters are preferably determined one or more times preferably during vehicle operation (e.g., while a vehicle user is using the vehicle), but can additionally or alternatively be determined upon enabling the vehicle (e.g., user sending a request to start a ride), continuously (e.g., while the vehicle is in motion, at all times while the vehicle is enabled, at all times, etc.), periodically (e.g., while the vehicle is in motion, at all times while the vehicle is enabled, at all times, etc.) (e.g., at a fixed frequency, at a user defined frequency, at a frequency determined from the user parameters such as: user profile; user ride history; etc., at a client defined frequency, depending on the current vehicle operation parameters, etc.), upon receipt of a prompt (e.g., user request to check vehicle operation parameters, client request to check vehicle operation parameters, external computing device, etc.), depending on vehicle operation parameters (e.g., sample and/or transmit every 15 seconds while the vehicle is in motion and every 60 seconds while the vehicle is at rest; when the current vehicle operation parameters have changed from the last measured vehicle operation parameters; depend on the vehicle speed; depend on vehicle location such as: outside a geographic region, inside a geographic region, etc.; etc.), when an event has occurred (e.g., a predetermined event, vehicle makes a turn, vehicle speed reaches a threshold speed, etc.), and/or at any other suitable time.

In one variation, the sampling rate for one or more vehicle operation parameters (and/or transmission rate) can vary as a function of the vehicle operation parameters (e.g., with vehicle speed), as a function of the primary geographic region and/or respective rules (e.g., inversely with primary geographic region size, vary with rule enforcement leniency, etc.), the vehicle operation parameter measurement accuracy (e.g., inversely with measurement accuracy), or otherwise vary. However, the vehicle operation parameters sampling rate can be specified by the geographic region's rules, be predetermined, be static, or otherwise determined.

The vehicle operation parameters are preferably determined based on measurements sampled by one or more sensors 260 (e.g., sensors such as described above regarding the system, such as vehicle and/or external sensors), but can additionally or alternatively be input manually (e.g., by a vehicle user, client, etc.), retrieved from memory (e.g., on-board memory, external memory such as: cloud storage, etc.), received from an external database (e.g., weather forecast transmission, database of road conditions (e.g., potholes, poor road quality, etc.), emergency database, etc.), and/or determined based on any other suitable information source(s). The information is preferably the vehicle operation characteristic value, but can additionally or alternatively be any suitable information.

The vehicle operation parameters are preferably stored by one or more computing systems (e.g., remote computing system, user device 300, vehicle processing module, etc.), such as stored in response to determination (e.g., wherein the information is determined by the computing system, wherein the information is transmitted to the computing system in response to being determined, etc.), and/or by any suitable system. The stored information can optionally be made available to all or some of the vehicle operation controllers (and/or to other authorized parties), such as to enable auditing of vehicle operation and/or associated information. In some examples, aspects of the stored information (e.g., associated with conformance to operation rules and/or lack thereof) can be brought to the attention of such parties (e.g., by providing alerts about the presence of such data, by highlighting such data in data inspection tools, etc.).

Determining vehicle operation parameters 5200 preferably includes determining vehicle location information. The vehicle location information can include geospatial position information (e.g., geospatial coordinates), position type information, and/or any other suitable information.

Vehicle location information can be determined (e.g., sampled, calculated) based on GNSS information (and/or enhanced GNSS information, such as RTK-GPS information, GNSS information supplemented by IMU and/or other positioning information, vehicle GPS supplemented with user device GPS, etc.), radio environment information (e.g., characteristics such as identifiers, RSSIs, and/or angles of arrival associated with radios such as Wi-Fi radios, Bluetooth beacons, cellular network radios, etc.; using auxiliary communication systems 240 to trilaterate vehicle location), dead reckoning or odometry information (e.g., determined based on measurements sampled by one or more IMU sensors, such as accelerometers, gyroscopes, and/or magnetometers), environmental mapping information (e.g., image recognition of environmental elements such as street signs and/or landmarks, such as performed using computer vision techniques; spatial mapping, such as using one or more time of flight sensors; etc.) preferably including correlation of the determined information (e.g., environmental elements, spatial maps, etc.) with map data (e.g., predetermined map data), routing or navigation instructions, or additionally or alternatively any other suitable information.

In a first variation, the vehicle location is determined based on multiple GPS points. For example, the vehicle location is determined based on the average location from two or more GPS points that were sampled within a predetermined time frame (e.g., concurrently sampled, 5 seconds, 30 seconds, 1 minute, etc.). The predetermined time frame can vary (e.g., inversely) with vehicle speed, be a constant time frame, or be otherwise determined. In a second variation, the vehicle location is determined by calculating the probability of the vehicle being in a location (e.g., based on user history, navigation, origin/destination, rider history, etc.). In a third variation, the vehicle can be considered located within a geofence (e.g., geographic region) when a predetermined number of GPS points fall within the geofence. The GPS points used to determine the vehicle location can be: consecutively GPS points (e.g., sampled by the vehicle), a predetermined number of GPS points within a predetermined timeframe (e.g., N points within a predetermined time period, such as 2 GPS points within 30 seconds, separated by any number of intervening GPS points outside of the geofence, etc.) or be any other suitable set of GPS points. However, the vehicle location can be otherwise determined.

The vehicle location can be determined: at a constant frequency, at a variable frequency, in response to a location determination condition being met, or at any other suitable time. In one variation, the vehicle location can be determined (and/or transmitted to the remote computing system) at a rate based on the vehicle kinematics, such as vehicle speed. For example, the GPS sampling rate (and/or transmission rate) can increase with increased vehicle speed, and decrease with decreased vehicle speed. This can function to accommodate for the increased geographic distance traveled over the same time frame at higher speeds, which can be particularly useful for spatial rule application. In a specific example, the vehicle can update the GPS data every 10 seconds when the vehicle speed is less than 5 mph, and every 5 seconds when the vehicle speed is above 5 mph, and every second when the vehicle speed is above 10 mph). The determination rate can vary linearly, exponentially, as a function of the desired geographic resolution and/or communication latency, be selected from a lookup table, or be otherwise determined based on the vehicle kinematics (e.g., speed, acceleration, etc.).

Position type information can be determined based on geospatial position information (e.g., correlated with position type map data, such as map data including paths and associated path types), image recognition such as recognition of features associated with one or more path types (e.g., image recognition of bike lane markings, pedestrians on a sidewalk, automobiles on a roadway, etc.), measurements (e.g., from accelerometers, audio sensors, cameras, time of flight sensors, etc.) indicative of path texture and/or topographic features (e.g., sidewalk control joints), and/or any other suitable information.

In an example, determining vehicle operation parameters S200 can additionally or alternatively include determining user parameters and/or vehicle condition parameters. For example, the user parameters (e.g., as described above) can be associated with user state (e.g., using images sampled by a user-facing camera, such as a camera of the vehicle or user device), such as determined based on image and/or video analysis (e.g., computer vision techniques) and/or analysis of measurements sampled by sensors (e.g., cameras, vehicle load and/or contact sensors, vehicle operation (e.g., swerving, response time, braking time, etc.), alcohol sensors, vehicle acceleration/deceleration, etc.). In specific examples, user parameters can be determined, such as: user equipment state (e.g., based on recognition of a helmet, such as a helmet worn by the user, in the image(s), based on communication system in the helmet indicating helmet is worn), user position (e.g., based on recognition of the user's body and/or body positioning, based on vehicle platform and/or handlebar load, etc.), number of users (e.g., based on a number of recognized body parts, such as faces, limbs, and/or torsos, such as body parts recognized via image analysis and/or contact/load sensors), and/or user cognitive state (e.g., determined based on facial analysis, measurements from an alcohol sensor such as a transdermal alcohol sensor, preferably arranged in the handlebars, etc.).

In an example, the determined user parameters can additionally or alternatively include driving characteristics (e.g., characteristics associated with vehicle speed, acceleration, swerving, braking, traffic law conformance, etc.). Such characteristics can be determined based on, for example: information sampled by vehicle sensors (e.g., IMU sensors, location sensors such as GNSS, vehicle operation sensors such as motor and/or brake state sensors, optical sensors such as cameras, etc.), information from vehicle control systems (e.g., motor controller), information from the user device(s), and/or any other suitable information.

In an example, the determined user parameters can additionally or alternatively include user experience and/or historical performance (e.g., as described above). For example, information associated with user experience and/or historical performance can be determined based on stored information associated with the user (e.g., user information database, such as a database available via a remote computing system; information stored by a user device, such as in association with the vehicle user and/or a native application of the user device associated with vehicle operation) and/or any other suitable information.

In an example, the determined user parameters can additionally or alternatively include environmental factors (e.g., associated with a region in which the vehicle is located). The environmental factors can be determined based on information sampled by sensors (e.g., sensors of the vehicle, user device, and/or external sensors, such as cameras, audio sensors, temperature sensors, pressure sensors, wind sensors, Doppler radar sensors, weather condition sensors, etc.), information received from weather information services (e.g., via the internet, via radio communication, etc.), and/or any other suitable information. However, the method can additionally or alternatively include determining any other suitable information in any suitable manner.

However, determining information associated with vehicle state S200 can additionally or alternatively include any other suitable elements.

### 4.3 Controlling Vehicle Operation.

Controlling vehicle operation S300 preferably functions to implement the vehicle operation rules based on the vehicle operation parameters. Controlling vehicle operation S300 preferably includes: selecting vehicle operation rules to apply based on the vehicle operation conditions; and enforcing the determined vehicle operation responses, but can additionally or alternatively include receiving vehicle operation rules, receiving vehicle operation parameters, and/or any other suitable elements. Controlling vehicle operation S300 preferably occurs after determining the vehicle operation rules and determining the vehicle operation parameters, but can additionally or alternatively be performed concurrently to determining vehicle operation rules S100 and determining vehicle operation parameters S200, and/or at any suitable time.

The vehicle operation rules can be received (e.g., at one or more control systems, such as the vehicle, remote computing system, user device, and/or any other suitable elements of the system) from the device(s) at which it is determined and/or stored (e.g., remote computing system), such as in embodiments in which it is not determined and/or stored at the control system. The vehicle operation rules can be received at and/or before the start of vehicle operation (e.g., start of a vehicle user's use session, such as the start of a vehicle rental session or a vehicle power-on event), during vehicle operation (e.g., throughout a use session, such as continuously, periodically, sporadically, and/or in response to triggers, etc.), and/or with any other suitable timing. The vehicle operation rules can be received in part (e.g., as an update to previously received vehicle operation rules), piecemeal (e.g., only receive vehicle operation rules for the immediate geographic region), in whole, and/or in any other suitable format.

The vehicle operation parameters can be received (e.g., at the control system) from the device(s) at which it is determined and/or stored (e.g., vehicle, user device, remote computing system, etc.), such as in embodiments in which it is not determined and/or stored at the control system. All or some of the vehicle operation parameters (e.g., historical vehicle user information, vehicle user safety factors such as proper helmet use, etc.) can be received at and/or before the start of vehicle operation, and/or when a change in the information is expected or likely (e.g., exceeding a threshold probability of changing) and/or with any other suitable timing. All or some of the vehicle operation parameters (e.g., parameters determined during vehicle use, such as location, speed, etc.) can additionally or alternatively be received during (e.g., throughout) vehicle operation (e.g., continuously, periodically, sporadically, in response to triggers, etc.) and/or with any other suitable timing. The vehicle operation parameters can be received in part (e.g., as an update to previously-received information), in whole, and/or in any other suitable format.

Selecting vehicle operation rules to apply based on the vehicle operation parameters is preferably performed by the vehicle (e.g., at the processing system, control system, etc.), but can additionally or alternatively be selected at a remote computing system, by the user device, manually, and/or in any suitable manner. The vehicle operation rules are preferably selected in response (e.g., immediately in response) to determining and/or receiving vehicle operation rules and/or vehicle operation parameters (e.g., original vehicle operation rules and/or vehicle operation parameters, updated vehicle operation rules and/or vehicle operation parameters, etc.), but can additionally or alternatively be selected at any other suitable time. The vehicle operation rules to apply are preferably selected based on comparing the vehicle operation conditions to the vehicle operation characteristic values (e.g., current vehicle operation parameters, within a predetermined historic time window, etc.), but can alternatively be selected based on the vehicle specifications, the vehicle identifier, the user identifier, the vehicle range, the expected vehicle geographic region, and/or otherwise selected. The selected vehicle operation rules are preferably communicated to the vehicle (e.g., in embodiments in which the vehicle is not the control system). In one example, selecting vehicle operation rules includes, for each vehicle operation condition of the vehicle operation rules, comparing the criteria associated with the vehicle operation condition to the vehicle operation parameter, wherein vehicle operation rules for which the vehicle operation condition and vehicle operation parameters match are selected.

In a specific example, selecting vehicle operation rules is performed locally at the vehicle. In this example, the vehicle receives the vehicle operation rules, samples the vehicle operation parameters (e.g., as described above), performs the comparison between the vehicle operation conditions and the vehicle operation parameters, determines whether the specific vehicle operation conditions are met, determines the requisite vehicle operation response(s), and applies the vehicle operation responses.

In another example, selecting vehicle operation rules is performed remotely (e.g., at a remote computing system). In this example, the vehicle samples the vehicle operation parameters (e.g., as described above), transmits the vehicle operation parameters to the remote computing system, wherein the remote computing system performs the comparison between the vehicle operation conditions and the vehicle operation parameters, determines whether the specific vehicle operation conditions are met, determines the requisite vehicle operation response(s) (and/or vehicle operation instructions to implement the response), transmits the requisite vehicle operation response(s) (and/or vehicle operation instructions) to the vehicle, wherein the vehicle applies the vehicle operation responses (and/or executes the vehicle operation instructions).

The vehicle operation rule selection can optionally be performed cooperatively by multiple control systems. For example, different control systems can perform vehicle operation rule selection from different vehicle operation rule subsets (e.g., kinematic rules, alert rules, overriding rules, etc.), and/or can perform tentative vehicle operation rules selection based on a subset of the vehicle operation conditions. In one embodiment, a remote computing system performs vehicle operation rule selection based on geoposition criteria, and the vehicle performs vehicle operation rule selection based on position type criteria. In one example, the remote computing system tentatively selects a first subset of vehicle operation rules based on geoposition criteria (and/or any other suitable criteria, preferably excepting position type criteria) and communicates the tentatively-selected vehicle operation rules to the vehicle. In this example, the vehicle then selects from the tentatively-selected vehicle operation rules based on position type criteria (and/or other criteria, preferably all the criteria not used by the remote computing system for the tentative selection). However, the vehicle operation rules can additionally or alternatively be selected in any other suitable manner.

Enforcing the determined vehicle operation responses is preferably performed automatically by the vehicle (e.g., at a control system of the vehicle), but can additionally or alternatively be performed by the user device, remote computing system, manually (e.g., implemented by a user, vehicle employee, ranger, etc.), and/or any other suitable entity. In one example, the vehicle operation response can include decreasing the vehicle speed. In this example, the vehicle operation response can be enforced by the vehicle (e.g., control system, motor controller, etc.) by controlling the motor to output less power, by remapping the throttle to different motor output, by applying the brakes, and/or by any other suitable method. In another example, the vehicle operation response can include a user alert. In this example, a vehicle output (e.g., graph, display, alarm, lights, haptic, etc.) can be configured to output a predetermined notification (e.g., pattern of lights, pattern of vibrations, specific sound, specific text alert, etc.) to notify a user.

In another example, the method can include: determining that a vehicle operation conditions satisfy a manual interference condition (e.g., the vehicle is parked in a no-parking zone); notifying an enforcement entity (e.g., an employee, a ranger, etc.), such as on the entity's user device; and facilitating enforcement entity enforcement of the rule (e.g., guiding the ranger to the vehicle for vehicle removal from the no-parking zone).

Enforcing the determined vehicle operation responses preferably occurs immediately after selecting the vehicle operation rules. However, vehicle operation responses can be enforced any time after vehicle operation conditions are meet (e.g., delayed by fixed amount of time, such as 10 s, 30 s, 60 s, etc.), after user acknowledges that responses need to be applied (e.g., via input on user device, input on vehicle, etc.), when it is safe for the vehicle operation response to be applied (e.g., when a set of safety conditions are met, such as when other vehicles 100 are determined to be a threshold distance away, when traffic is less than a predetermined density, based on road type, etc.), when an accident probability is below a threshold probability (e.g., as determined by a neural network), based on user parameters (e.g., user is paying attention to the road, which can be determined from distraction metrics, rider facing images, user device usage, etc.), upon receiving a signal to apply the vehicle operation response (e.g., from an external server), upon detection of an imminent vehicle operation condition being met, and/or at any other suitable timing. Enforcing the determined vehicle operation responses preferably includes alerting the vehicle user (e.g., display, visually, aurally, haptically, etc.) to the upcoming vehicle operation response enforcement, but additionally or alternatively not alert the vehicle user, alert the vehicle user when new vehicle operation conditions (e.g., new vehicle operation conditions have been received, new vehicle operation condition have been found to apply, etc.), and/or be performed in any suitable manner.

Enforcing the vehicle operation responses preferably depends on the vehicle operation response, but can additionally or alternatively be applied in the same manner regardless of vehicle operation response, and/or in any suitable manner.

In one variation, enforcing kinematic vehicle operation responses (e.g., changing vehicle speed) is preferably performed in a manner that ensures a positive user experience. For example, enforcing the kinematic vehicle response can include limiting the vehicle jerk 227 to below a threshold value (e.g., 0.25 m/s³, 0.5 m/s^{3, 1} m/s³, between 0.1 and 1 m/s³, etc.), wherein vehicle jerk 227 can be the first derivation of the vehicle acceleration with respect to time. In a first embodiment, limiting the vehicle jerk 227 below a threshold is preferably performed by modifying vehicle operation parameters (e.g., speed) according to an equation (e.g., linear, logarithmic, etc.). Inputs to the equation can include: user parameters (e.g., mass), vehicle condition parameters (e.g., brake status), vehicle operation parameters (e.g., current vehicle speed, target vehicle speed, maximum vehicle speed, vehicle acceleration, etc.), or any other suitable set of inputs.

However, managing vehicle jerk 227 can include adjusting the vehicle speed (e.g., speed cap): stepwise (e.g., to decrease speed, do so in discrete speed steps between current speed and target speed), based on machine learning (e.g., according to algorithm for target speed profile), consistent with how “good” users perform the transition, manually specified (e.g., employee input behavior for modifying vehicle operation parameters), and/ or adjusting the vehicle speed in any suitable manner.

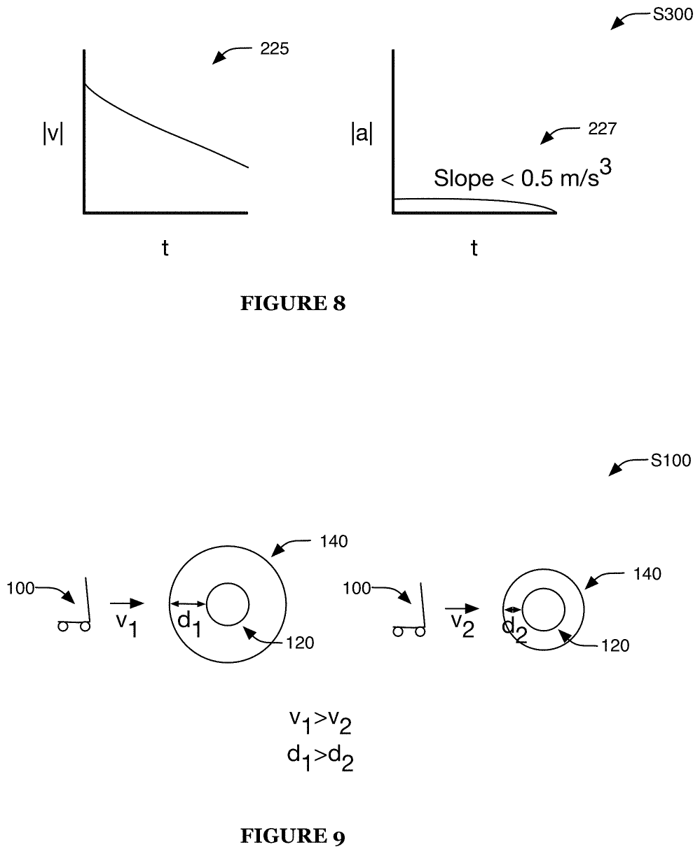

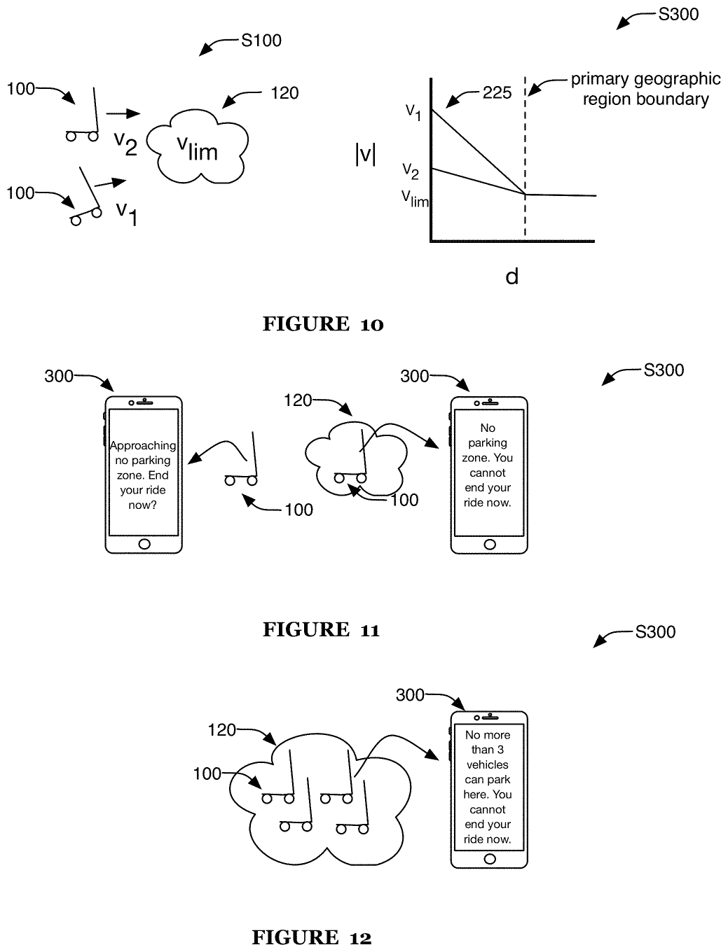

In a specific example, as shown in FIG. 8 and FIG. 10, wherein the vehicle operation response includes transitioning to a target speed, a target speed profile 225 is determined (e.g., based on vehicle operation parameters, user parameters, etc.) that features desired kinematic parameters (e.g., vehicle jerk 227 below a threshold, vehicle acceleration/deceleration below a threshold, target speed reached within a given amount of time, target speed reached within a given distance, etc.). The vehicle (e.g., the control system) can change the vehicle speed to match the vehicle speed to the target speed profile 225. The vehicle speed can be changed by remapping the throttle, tuning the motor output, applying brakes, or otherwise adjusted. In this example, the target speed profile 225 can depend on the primary geographic region (e.g., primary rules) and secondary geographic region (e.g., distance between the secondary geographic region's boundary and/or the secondary rules), be the same for primary geographic regions and secondary geographic regions, be different for primary and secondary geographic regions, and/or be determined in any suitable manner.

In specific embodiments, enforcing notification vehicle operation responses can include determining what notification to present to the user (e.g., based on which vehicle operation rule was selected, what vehicle operation rules are predicted to apply next (e.g., based on learning algorithm, vehicle speed, vehicle direction of motion, vehicle predicted trajectory, etc.), vehicle operation parameters, user parameters, etc.) and presenting the notification to the user (e.g., on the vehicle, on the user device, on an external device, etc.). In a specific example, when a vehicle is located in a secondary geographic region adjacent to a primary geographic region that is a vehicle restricted region, a vehicle display can be configured to present a warning to the user (such as “Warning: vehicles prohibited in primary geographic region”). In another specific example, if the vehicle route is anticipated to overlap with the vehicle restricted region (e.g., based on origin and/or destination, predicted route, etc.), the computing system (e.g., on the vehicle, user device, external computing system 400, etc.) can suggest (e.g., display) alternate routes that avoid the primary geographic region as part of the vehicle operation response.

In another example, when the vehicle operation response includes preventing a user from terminating the vehicle use within a geographic region (e.g., when the vehicle operation condition limits vehicle parking in the geographic region), can include presenting a notification to the user (e.g., on the vehicle, on the user device, etc.) of the conditions to the user (e.g., a notification saying “Warning, vehicle parking is restricted in this primary geographic region”), or otherwise enforcing the geographic region rules. In this specific example, if the user proceeds to violate the vehicle operation condition (e.g., by parking the vehicle), the vehicle operation response could be to present a second notification to the user, such as “Warning, vehicle parking is restricted in this primary geographic region. A fine will be charged if you park in this primary geographic region.” Alternatively or additionally (e.g., if the user proceeds to ignore this notification), the vehicle operation response can include updating the user parameters (e.g., user history, user profile, user account balance, etc.) and notify the user of the fee (e.g., by presenting the notification “a fee of $$$ has been charged to your account for failure to follow the vehicle operation conditions”). Additionally or alternatively, if the vehicle is located in a secondary geographic region surrounding the primary geographic region, the vehicle operation response can include suggesting that the user park in the secondary geographic region (e.g., with a notification such as “Parking is restricted in the upcoming primary geographic region. Would you like to terminate your ride?”). Additionally or alternatively, in this example, the vehicle operation response in the primary geographic region can include preventing the motor of the vehicle from having its output power completely shut off or precluding riding session termination (e.g., continue charging the user for the riding session while the vehicle remains within the geographic region), and/or include any suitable vehicle operation responses.

In another specific example, when the vehicle operation conditions include a restriction based on the number of vehicles 100 in a primary geographic region (e.g., a maximum number of vehicles that can be parked in a geographic region, a predetermined density of vehicles that can be within the geographic region), the vehicle operation response can include determining the number of vehicles present in the primary geographic region. Determining the number of vehicles with the primary geographic region can be accomplished using vehicle to vehicle communication (e.g., short range communication systems, vehicle communication systems, etc.; such as by determining the number of vehicles on a local wireless area network, the number of other vehicles available for Bluetooth connection, etc.), computer vision (e.g., taking a picture of the surrounding region and identifying any vehicles present in the area), by a remote computing system (e.g., identifying the number of vehicles at the location based on the number of vehicles trying to access a remote computing system, remote tracking of vehicle locations, etc.), and/or by any suitable manner. In this specific example, the vehicle location can be determined as above, or otherwise determined.

In another example, when the vehicle operation response includes preventing a user from initiating vehicle use. For example, vehicle use can be prohibited upon satisfaction of a vehicle operation condition prohibiting users that are impaired (e.g., intoxicated). Preventing vehicle use can include: presenting a notification to the user (e.g., on the vehicle, on the user device, etc.), wherein the notification can include the conditions to the user (e.g., a notification saying “Warning, vehicle use prohibited for intoxicated users”); preventing motor engagement; not providing power to the motor; or otherwise preventing vehicle use.

In specific embodiments, enforcing user activity responses can include determining how to change user parameters (e.g., add note in user profile, add charges to user account, apply discount to user account, update user history, etc.), accessing the user parameters (e.g., connecting to server hosting user parameters, locally change user parameters, update user parameters through client application on user device, etc.), and modifying the user parameters. In a specific example, the vehicle operation response can include notifying the user of their ride statistics and updating their user profile. For example, the user's rider score can be increased when the user's trip is minimally influenced (e.g., fewer automatic prompts or changes to vehicle operation parameters than a threshold number of automatic interferences, extent of automatic prompts was lower than a threshold, etc.). However, the user profile can be otherwise modified.

In specific embodiments, enforcing overriding vehicle operation responses (e.g., not enforcing vehicle operation responses) can include determining when to override vehicle operation response, determining how long to override vehicle operation responses, determining which vehicle operation responses to override, operating the computing system (e.g., vehicle, user device, external computing system 400, etc.) in accordance with the determined vehicle operation responses not being applied for the determined length of time, and/or overriding vehicle operation responses in any other suitable manner.

The vehicle operation response can be overridden: in response to satisfaction of a vehicle operation condition, manually (e.g., user instruction, employee instruction, etc.), for safety concerns (e.g., traffic density is too high, proximity of other vehicles is too close, etc.), or at any other suitable time. Examples of vehicle operation conditions that can be satisfied include: the vehicle direction of travel is directed away from the primary geographic region; the vehicle probability of entering the primary geographic regions falls below a threshold probability (e.g., based on route, historical user data, etc.), or any other suitable set of conditions.

The vehicle operation response can be overridden: for the remainder of the current ride, for all future rides for the user, until a specific trigger event occurs (e.g., the vehicle enters a new geographic region, vehicle speed reaches a threshold speed, vehicle turns, etc.), for a given duration, or for any suitable amount of time.

The specific vehicle operation responses to override can be: all vehicle operation responses, a subset of vehicle operation responses (e.g., all kinematic vehicle operation responses, all vehicle operation responses relating to a given geographic region, all vehicle operation responses corresponding to vehicle operation conditions that depend on user impairment state, etc.), or otherwise determined.

In specific embodiments of the method including one or more primary geographic regions and one or more secondary geographic regions, controlling vehicle operation S300 can be performed in the same manner for different geographic regions, can be performed in the same manner for geographic regions that are adjacent to one another, can be correlated with the manner that the vehicle operation is controlled in adjacent geographic regions, can be un correlated with adjacent geographic regions, can be correlated for a subset of how the vehicle operation is controlled and not correlated for other subsets of how the vehicle operation is controlled in other geographic regions, and/or can be controlled in any suitable manner across different geographic regions.

### 5. Illustrative Variants.

In a first illustrative example, the system defines a primary geographic region and a secondary geographic region adjacent to the primary geographic region, wherein the vehicle operation rules are different in the primary geographic region and in the secondary geographic region. In the primary geographic region, the vehicle operation conditions include a parking restriction (e.g., no vehicle parking when the vehicle is located within the primary geographic region). In the primary geographic region, the vehicle operation response can include alerting the user to the parking restriction and preventing the user from terminating the vehicle use. In the secondary geographic region, the vehicle operation conditions include determining if the user is: within the secondary geographic region and approaching the primary geographic region (e.g., whether the distance between the primary and secondary geographic regions is decreasing, whether the vehicle direction of motion is toward the primary geographic region, whether the vehicle route predicted to intersect the primary geographic region, etc.). In the secondary geographic region, the vehicle operation response can include alerting the user to the upcoming primary geographic region conditions and suggesting to the user to park in the secondary geographic region. In this example, determining the vehicle operation parameters can include determining the vehicle location, vehicle direction of motion, vehicle route, destination, vehicle engage state, or any other suitable set of vehicle operation parameters. In this example, controlling the vehicle operation in the primary geographic region can include: presenting a notification to the user of the vehicle operation condition (e.g., on a vehicle display, on a user device, etc.), preventing the vehicle engage state from being changed (e.g., prevent the user from terminating the ride), if the user persists in modifying the vehicle engage state, presenting a notification that the user can modify the vehicle engage state but will be charged a fee (and modifying the vehicle engage state if the user accepts the fee), and updating the user parameters (e.g., user profile, user account) to reflect the fee. In this example, controlling the vehicle operation in the secondary geographic region can include: presenting a notification to the user of the upcoming primary geographic region and the primary geographic region vehicle operation condition (e.g., on a vehicle display, on a user device, etc.), and offering the user an opportunity to change the vehicle engage state while in the secondary geographic region (e.g., through the client application, on the vehicle, etc.).

In a second illustrative example, the system can define a primary geographic region and a secondary geographic region adjacent to the primary geographic region, wherein the vehicle operation rules are different in the primary geographic region and in the secondary geographic region. In this example, determining the vehicle operation parameters can include determining the vehicle location, vehicle direction of motion, vehicle route, destination, or determining any other suitable vehicle parameter.

In the primary geographic region, the vehicle operation conditions exclude vehicles within the primary geographic region (e.g., no vehicles allowed). In the primary geographic region, the vehicle operation response can include alerting the user to the vehicle restriction and terminating power to the vehicle motor.

In the secondary geographic region, the vehicle operation conditions include: applying a secondary response when the vehicle is located within the secondary geographic region and is approaching the primary geographic region (e.g., the distance between the primary and secondary geographic regions is decreasing, the vehicle direction of motion is directed toward the primary geographic region, the vehicle route is predicted to intersect the primary geographic region, etc.).

In the secondary geographic region, the secondary response can include: presenting a notification to the user of the upcoming primary geographic region and/or the primary geographic region vehicle operation condition (e.g., on a vehicle display, on a user device, etc.), reducing the vehicle speed (e.g., cutting engine power, remap the vehicle throttle, apply the brakes, etc.) based on the separation distance between the vehicle and the primary geographic region (e.g., modify the vehicle speed as a function of distance from the primary geographic region boundary, such as setting the vehicle speed to 0 mph within 10 ft of the boundary), locking the vehicle steering control to preclude the vehicle from turning toward the primary geographic boundary (e.g., within a predetermined distance of the primary geographic region boundary), and/or reengaging and/or increasing allowed vehicle speed if the vehicle stops traveling toward the primary geographic region.

In a third illustrative example, the system defines a primary geographic region and a secondary geographic region adjacent to the primary geographic region, wherein the vehicle operation rules are different in the primary geographic region and in the secondary geographic region.

In the primary geographic region, the vehicle operation conditions include restricting a vehicle operation parameter, such as setting an upper bound on a vehicle speed (e.g., 3, 5, 8, 10, 15 mph etc.) within the primary geographic region. In the primary geographic region, the vehicle operation response can include alerting the user to the primary geographic region speed limit and reducing the vehicle operation speed to the speed limit. In this example, controlling the vehicle operation within the primary geographic region can include: presenting a notification to the user of the vehicle operation condition (e.g., on a vehicle display, on a user device, etc.) and decreasing the vehicle speed to at most the primary geographic region speed limit (e.g., by decreasing motor power, applying the brake, remapping the throttle, etc.).

In the secondary geographic region, the vehicle operation conditions can include: determining that the vehicle is located within the secondary geographic region, determining that the vehicle is approaching the primary geographic region (e.g., the distance between the primary and secondary geographic regions is decreasing, the vehicle direction of motion is toward the primary geographic region, the vehicle route is predicted to intersect the primary geographic region, etc.).

The method can additionally include, when (e.g., while) the vehicle operation condition is satisfied: restricting the vehicle operation parameter, but less restrictively than in the primary geographic region (e.g., setting an upper bound in the secondary geographic region based on the speed limit in the primary geographic region, such as 5, 8, 10, 12, 18 mph, etc.); setting the secondary geographic region speed limit based on whether the vehicle is traveling toward the primary geographic region; or otherwise restricting the vehicle operation parameter. In this example, controlling the vehicle operation in the secondary geographic region can additionally or alternatively include: presenting a notification to the user of the upcoming primary geographic region vehicle operation condition and the secondary geographic region condition (e.g., on a vehicle display, on a user device, etc.) and reducing the vehicle speed (e.g., cutting engine power, remap the vehicle throttle, apply the brakes, etc.) to at most the secondary geographic region speed limit.

In this example, if the vehicle is in the secondary geographic region, but the vehicle direction of motion is not toward the primary geographic region, then the secondary geographic region speed limit can be overridden, or can be set to a higher speed limit than if the vehicle direction of motion is toward the primary geographic region. The secondary geographic region speed limit can be set based on the degree to which the vehicle direction of motion is directed toward the primary geographic region (e.g., angle formed between vehicles current trajectory and the shortest trajectory that connects the vehicle location to the primary geographic region boundary, predicted probability of the vehicle intersecting the primary geographic region, etc.).

In a fourth illustrative example, the vehicle operation response is to decrease the speed of the vehicle in a given period of time, while introducing minimal jerk. In this example, determining vehicle operation parameters S200 can include determining vehicle speed, road conditions (e.g., traction, road wear, etc.), user parameters (e.g., mass), and vehicle condition parameters (e.g., vehicle brake wear, vehicle engine output power, etc.). Controlling the vehicle operation includes determining a preferred speed profile, and slowing the vehicle (e.g., remapping the throttle, cutting engine power, applying the brakes) to change the speed of the vehicle following the preferred vehicle speed profile. The preferred speed profile can be determined: from an equation (e.g., based on initial speed, target speed, max vehicle speed, current vehicle speed, etc.), empirically (e.g., following the behavior of ‘good’ users), learned (e.g., using a machine learning algorithm), selected from a lookup table, or otherwise determined. Additionally or alternatively, controlling vehicle operation can include determining a set of vehicle control instructions and/or curves (e.g., throttle remapping instructions, engine power limiting instructions, etc.). However, the vehicle operation response can be otherwise controlled.

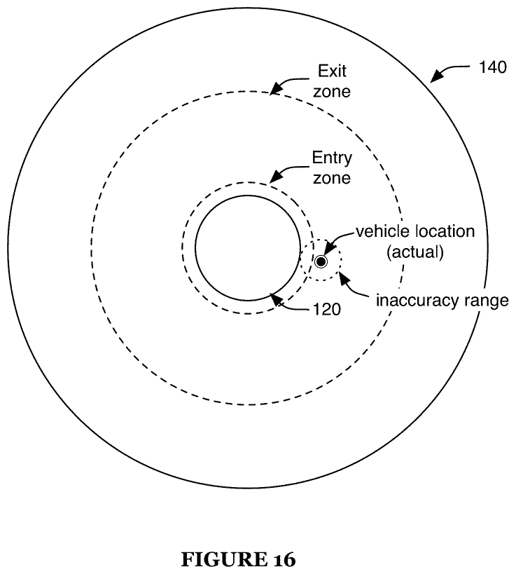

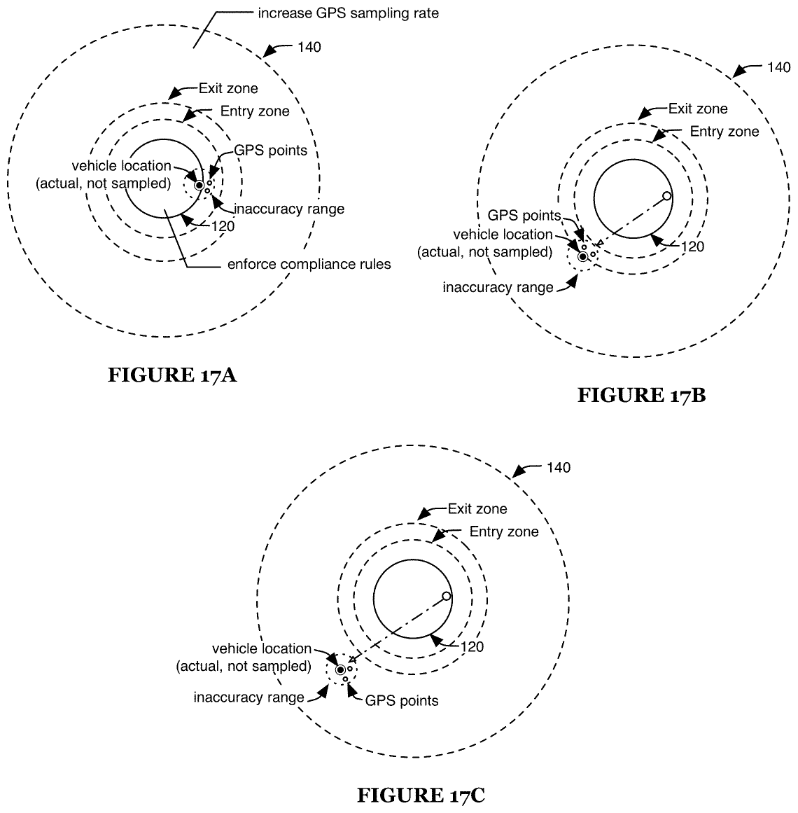

In a fifth illustrative example, as shown in FIG. 16 and FIGS. 17A-17C, a primary geographic region can be surrounded by at least three secondary geographic regions. In this example, the vehicle operation parameters are checked at a first sampling rate (e.g., every 10 seconds, 15 seconds, depending on the vehicle speed, etc.) when the vehicle is outside of the outermost secondary region (e.g., when the vehicle enters the monitored zone). In a specific example, when the vehicle enters the outermost secondary geographic region, the sampling rate of the vehicle operation parameters changes to a second sampling rate greater than the first sampling rate (e.g., every 5 seconds, 7 seconds, a multiple of the first sampling rate, such as twice the first sampling rate, etc.). If the vehicle location is determined to be within an entry zone (e.g., a secondary geographic region), then the vehicle is considered to have entered the primary geographic region (compliance zone) and needs to satisfy the primary geographic region rules (e.g., the primary geographic region's rules are automatically enforced). Once the vehicle is considered within the primary geographic region (e.g., has entered the innermost secondary geographic region), the primary geographic region's rules can be enforced until the vehicle is considered to have left the primary geographic region. In one variation, the vehicle can be considered to have left the primary geographic region (and have primary geographic rule enforcement removed) once the vehicle location falls outside an exit zone (e.g., a secondary geographic region). The exit zone can be: the primary geographic region, a secondary geographic region surrounding the primary geographic region (e.g., smaller than the entry zone, larger than the entry zone, etc.), or otherwise defined. The distance between the compliance zone and the exit and/or entry zones can be: predetermined (e.g., 5 m, 1 m, etc.), determined based on the vehicle's GPS inaccuracy (e.g., be the GPS inaccuracy range or the GPS horizontal accuracy distance, be a multiple of the GPS inaccuracy range, such as 2× the GPS inaccuracy range), be determined based on historical GPS inaccuracy for the geographic unit or area, be determined based on the vehicle speed (e.g., larger for higher speeds), or be otherwise determined. The exit zone is preferably larger than (e.g., surrounds) the entry zone to reduce the possibility of false negatives (e.g., vehicles that are actually within the compliance zone, but have perceived vehicle locations outside of the compliance zone due to GPS noise), but can additionally or alternatively be smaller than (e.g., arranged within) the entry zone, equivalent to the entry zone, or otherwise arranged relative to the entry zone.

Although omitted for conciseness, the preferred embodiments include every combination and permutation of the various system components and the various method processes. Furthermore, various processes of the preferred method can be embodied and/or implemented at least in part as a machine configured to receive a computer-readable medium storing computer-readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processing subsystem, but any suitable dedicated hardware device or hardware/firmware combination device can additionally or alternatively execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method for vehicle control in a primary geographic region, comprising:
determining vehicle operation parameters of the vehicle at a first sampling rate;
determining primary geographic region conditions and primary geographic region responses associated with the primary geographic region;
determining a secondary geographic region, adjacent to the primary geographic region, based on the primary geographic region and the vehicle operation parameters;
determining secondary geographic region responses associated with the secondary geographic region, the secondary geographic region responses comprising a second sampling rate based on the first sampling rate; and
automatically enforcing the secondary geographic region responses when the vehicle operation parameters indicate vehicle location within the secondary geographic region; and
automatically enforcing the primary geographic region responses when the vehicle operation parameters satisfy the primary geographic region conditions.

2. The method of claim 1, wherein the vehicle operation parameters comprise a vehicle direction of motion, and automatic enforcement of the secondary geographic region responses depends on the vehicle direction of motion.

3. The method of claim 1, wherein the first sampling rate is based on the vehicle operation parameters, and wherein the vehicle operation parameters comprise a speed of the vehicle.

4. The method of claim 1, wherein determining the primary geographic region conditions and the secondary geographic region further comprises:
connecting the vehicle to an external server;
at the vehicle, receiving primary geographic region information and secondary geographic region information from the external server;
updating one or more of the primary geographic region, the primary geographic region conditions, and the primary geographic region responses based on the primary geographic region information; and
updating one or more of the secondary geographic region, the secondary geographic region conditions, and the secondary geographic region responses based on the secondary geographic region information.

5. The method of claim 1, further comprising:
determining whether a route between an origin and a destination intersects the primary geographic region; and
when the route does not intersect the primary geographic region, overriding the secondary geographic region responses.

6. The method of claim 5, further comprising, when the route intersects the primary geographic region, suggesting an alternate route that does not pass through the primary geographic region.

7. The method of claim 1, wherein:
the vehicle operation parameters are measured during a driving session;
wherein the primary geographic region conditions comprise restricting vehicle parking within the primary geographic region;
wherein automatically enforcing the primary geographic region responses further comprises:
alerting a vehicle user to the primary geographic region conditions; and
preventing the user from terminating the driving session within the primary geographic region; and
wherein automatically enforcing the secondary geographic region responses further comprises:
alerting the vehicle user to the primary geographic region and the primary geographic region conditions; and
offering the user an opportunity to park in the secondary geographic region.

8. The method of claim 1, wherein the primary geographic region responses comprise restricting a speed of the vehicle to a primary geographic region speed limit within the primary geographic region, and wherein automatically enforcing the primary geographic region responses further comprises:
alerting a vehicle user to the primary geographic region speed limit;
measuring the speed of the vehicle; and
when the speed is greater than the primary geographic region speed limit, reducing the speed of the vehicle to at most the primary geographic region speed limit.

9. The method of claim 8, further comprising:
an entry geographic region adjacent the primary geographic region, wherein the primary geographic region responses are enforced in response to vehicle entry into the entry geographic region; and
an exit geographic region adjacent the entry geographic region, wherein the primary geographic region responses are enforced until a vehicle exits the exit geographic region.

10. The method of claim 9, wherein the vehicle operation parameters comprise an accuracy distance for vehicle location measurements sampled by the vehicle, wherein the entry geographic region and the exit geographic region are separated by a separation distance determined based on the accuracy distance.

11. The method of claim 1, wherein:
the primary geographic region conditions comprise a vehicle restricted zone; and
wherein automatically enforcing the secondary geographic region responses further comprises:
alerting the vehicle user to the vehicle restricted zone;
determining a separation distance between the vehicle and the primary geographic region; and
reducing a speed of the vehicle based on the separation distance.

12. The method of claim 1, wherein:
automatically enforcing the secondary geographic region responses further comprises enforcing the secondary geographic region responses according to a secondary target speed profile of the vehicle, wherein the secondary target speed profile is determined based on the vehicle operation parameters, user parameters, and the primary geographic region conditions, to control a jerk of the vehicle;
wherein automatically enforcing the primary geographic region responses further comprises enforcing the primary geographic region responses according to a primary target speed profile of the vehicle, wherein the primary target speed profile is determined based on the vehicle operation parameters, user parameters, and the primary geographic region conditions, to control the jerk of the vehicle; and
automatically enforcing the secondary geographic region responses and automatically enforcing the primary geographic region responses comprises limiting the jerk of the vehicle to 0.5 m/s³ or less.

13. A method for vehicle control in a primary geographic region, comprising:
determining vehicle operation parameters;
determining primary geographic region conditions and primary geographic region responses associated with the primary geographic region;
determining a secondary geographic region adjacent to the primary geographic region, secondary geographic region conditions based on the primary geographic region conditions, and secondary geographic region responses based on the primary geographic region conditions; and
when the vehicle operation parameters satisfy the secondary geographic region conditions, automatically enforcing the secondary geographic region responses according to a secondary geographic region target speed profile of the vehicle, wherein the secondary geographic region target speed profile is determined, based on the vehicle operation parameters, user parameters, and the primary geographic region conditions, to control a jerk of the vehicle.

14. The method of claim 13, wherein automatically enforcing the secondary geographic region responses comprises controlling the vehicle to limit the jerk to 0.5 m/s³ or less.

15. The method of claim 13, wherein:
the vehicle operation parameters are determined at a first sampling rate; and
wherein automatically enforcing the secondary geographic region responses further comprises determining the vehicle operation parameters at a second sampling rate.

16. The method of claim 15, wherein:
the vehicle operation parameters comprise a speed of the vehicle and a vehicle location;
wherein the vehicle location is sampled at the first sampling rate when the secondary geographic region conditions are not met, wherein the first sampling rate is based on the speed of the vehicle; and
wherein the vehicle location is sampled at the second sampling rate when the secondary geographic region conditions are met, wherein the second sampling rate is higher than the first sampling rate.

17. The method of claim 13, wherein determining the primary geographic region conditions and the secondary geographic region further comprises:
connecting the vehicle to an external server;
at the vehicle, receiving primary geographic region information and secondary geographic region information from the external server; and
updating one or more of the primary geographic region, the primary geographic region conditions, and the primary geographic region responses based on the primary geographic region information and updating one or more of the secondary geographic region, the secondary geographic region conditions, and the secondary geographic region responses based on the secondary geographic region information.

18. The method of claim 13, further comprising:
an entry geographic region adjacent the primary geographic region, wherein the primary geographic region responses are enforced in response to vehicle entry into the entry geographic region; and
an exit geographic region adjacent the entry geographic region, wherein the primary geographic region responses are enforced until a vehicle exits the exit geographic region.

19. The method of claim 18, wherein the vehicle operation parameters comprise an accuracy distance for vehicle location measurements sampled by the vehicle, wherein the entry geographic region and the exit geographic region are separated by a separation distance determined based on the accuracy distance.

20. The method of claim 13, wherein automatically enforcing the secondary geographic region responses comprises:
determining a separation distance between the vehicle and the primary geographic region; and
reducing a speed of the vehicle based on the separation distance.
